(19) United States
(12) Patent Application Publication
(10) Pub. No.: US 2026/0321276 A1
(43) Pub. Date: Oct. 15, 2026

(54) ADAPTIVE, FREQUENCY-DOMAIN SPATIAL DECORRELATION OF AUDIO SIGNALS

(71) Applicant: KONINKLIJKE PHILIPS N.V., EINDHOVEN (NL)

(72) Inventors: Cornelis Pieter Janse, Eindhoven (NL); Brian Brand Antonius Johannes Bloemendal, Eindhoven (NL); Rik Jozef Martinus Janssen, Eindhoven (NL)

(21) Appl. No.: 19/485,356

(22) PCT Filed: May 21, 2024
(86) PCT No.: PCT/EP2024/063873

§ 371 Date: Nov. 18, 2025

(30) Foreign Application Priority Data
May 30, 2023 (EP) 23176031.5

(51) Int. Cl. G10L 21/0308; G10L 25/18

(52) U.S. Cl. CPC G10L 21/0308; G10L 25/18

(57) ABSTRACT

An audio apparatus comprises a receiver (101) arranged to receive a set of input audio signal which are segmented by a segmenter (103). An output signal generator (105) generates output audio signals by for each segment performing the steps of: generating (201) a frequency bin representation of input audio signals; generating (203) a frequency bin representation of the output audio signals as a weighted combination of frequency bin values of the input audio signals for the frequency bin; converting the frequency bin representation to the time domain. An adapter (107) updates the weights for a given weight in response to a correlation measure between output frequency bin values for the output audio signal being generated and an output audio signal linked to the input signal being weighted by the weight. The approach may typically provide improved frequency domain adaptive spatial decorrelation of audio signals.

### FIELD OF THE INVENTION

The invention relates to an apparatus and a method for generating audio output signals, and in particular, but not exclusively, to generating decorrelated audio signals for e.g., speech signals.

### BACKGROUND OF THE INVENTION

Capturing audio, and in particularly speech, has become increasingly important in the last decades. For example, capturing speech or other audio has become increasingly important for a variety of applications including telecommunication, teleconferencing, gaming, audio user interfaces, etc. However, a problem in many scenarios and applications is that the desired audio source is typically not the only audio source in the environment. Rather, in typical audio environments there are many other audio/noise sources which are being captured by the microphone. Audio processing is often desired to improve the capture of audio, and in particular to post-process the captured audio time interval improve the resulting audio signals. For example, speech enhancement, beamforming, noise attenuation and other functions are often used.

In many embodiments, audio may be represented by a plurality of different audio signals that reflect the same audio scene or environment. In particular, in many practical applications, audio is captured by a plurality of microphones at different positions. For example, a linear array of a plurality of microphones is often used to capture audio in an environment, such as in a room. The use of multiple microphones allows spatial information of the audio to be captured. Many different applications may exploit such spatial information allowing improved and/or new services.

However, an issue that in practice may tend to reduce the performance and capture is that different audio sources tend to be captured (differently) in the different microphones depending on the specific properties and position of the audio source relative to the microphones. This may typically make it difficult and resource demanding to process the audio signals and in particular to determine which and how different audio sources contribute to the captured audio for the different microphones. It is often challenging to process multiple captured audio signals that are correlated, and typically with an unknown correlation.

One approach that may seek to address such issues is to try to separate audio sources by applying beamforming to form beams directed towards the direction of arrival of audio from specific audio sources. However, although this may provide advantageous performance in many scenarios, it is not optimal in all cases. For example, it may not provide optimal source separation in some cases or indeed in some applications such a spatial beamforming does not provide audio properties that are ideal for further processing to achieve a given effect.

It has been proposed that in some cases where the relationship between audio sources and microphones are known (e.g. by the acoustic impulse response between the audio source and the capture position being known) then this information can be used to generate decorrelated signals from the microphone signal. The known acoustic impulse responses from the different audio sources to the different microphone signals can be used to convert the microphone signals into signals where the audio from individual audio sources are more concentrated in different signals. Such signals may in some cases provided an improved audio or speech capture or processing.

However, whereas such an operation may be desirable in many situations and scenarios, there are also substantial issues, challenges, and disadvantages. Indeed, in most practical applications the acoustic relationship and specifically the acoustics transfer functions/impulse responses between audio sources and microphones are simply not known. Even small differences between the actual and used values can result in significant degradation in the generated signals and the subsequent processing.

Hence, an improved approach would be advantageous, and in particular an approach allowing reduced complexity, increased flexibility, facilitated implementation, reduced cost, improved audio capture, improved spatial perception/differentiation of audio sources, improved audio source separation, improved audio/speech application support, improved spatial decorrelation of audio signals, reduced dependency on known or static acoustic properties, improved flexibility and customization to different audio environments and scenarios, and/or improved performance would be advantageous.

### SUMMARY OF THE INVENTION

Accordingly, the Invention seeks to preferably mitigate, alleviate or eliminate one or more of the above mentioned disadvantages singly or in any combination.

According to an aspect of the invention there is provided an audio decorrelation apparatus for generating a set of output audio signals being decorrelated signals of a set of input audio signals, the audio apparatus comprising: a receiver arranged to receive the set of input audio signals; a segmenter arranged to segment the set of input audio signals into time segments; an output signal generator arranged to generate the set of output audio signals, each output audio signal of the set of output audio signals being linked with an input audio signal of the set of input audio signals, the output signal generator being arranged to for each time segment perform the steps of: generating a frequency bin representation of the set of input audio signals, each frequency bin of the frequency bin representation of the set of input audio signals comprising a frequency bin value for each of the input audio signals of the set of input audio signals; generating a frequency bin representation of the set of output audio signals, each frequency bin of the frequency bin representation of a set of output audio signals comprising a frequency bin value for each of the set of output audio signals, the frequency bin value for a given output audio signal of the set of output audio signals for a given frequency bin being generated as a weighted combination of frequency bin values of the set of input audio signals for the given frequency bin; generating a time domain representation for each output audio signal from the frequency bin representation of the set of output audio signals; an adapter arranged to update weights of the weighted combination; wherein the adapter is arranged to update a first weight for a contribution to a first frequency bin value of a first frequency bin for a first output audio signal linked with a first input audio signal from a second frequency bin value of the first frequency bin for a second input audio signal linked to a second output audio signal in response to a correlation measure between a first previous frequency bin value of the first output audio signal for the first frequency bin and a second previous frequency bin value of the second output audio signal for the first frequency bin; and wherein the adapter is further arranged to update a second weight being for a contribution to the first frequency bin value from a third frequency bin value being a frequency bin value of the first frequency bin for the first input audio signal in response to a magnitude of the first previous frequency bin value.

The approach may provide improved operation and/or performance in many embodiments. It may provide an advantageous generation of output audio signals with typically increased decorrelation in comparison to the input signals. The approach may provide an efficient adaptation of the operation resulting in improved decorrelation in many embodiments. The adaptation may typically be implemented with low complexity and/or resource usage. The approach may specifically apply a local adaptation of individual weights yet achieve an efficient global adaptation.

The generation of the set of output signals may be adapted to provide increased decorrelation relative to the input signals which in many embodiments and for many applications may provide improved audio processing. For example, in many situations speech enhancement, noise suppression, or beamforming may be improved if such audio processing is performed on audio signals that are less correlated.

The first and second output audio signals may typically be different output audio signals.

The adapter may be arranged to determine a magnitude measure for the first previous frequency bin value and to update the second weight in dependence on the magnitude measure.

In some embodiments, the update of the second weight may be dependent only on previous frequency bin values of the first frequency bin of the first output audio signal. In some embodiments, the update of the second weight may be dependent only on the first previous frequency bin value.

In some embodiments, the update of the first weight may be dependent only on previous frequency bin values of the first frequency bin of the first output audio signal and the second output audio signal, and specifically only on the correlation measures of these (specifically for the same time segment).

In some embodiments, the update of the first weight may be dependent only on the first previous frequency bin value and the second previous frequency bin value.

In many embodiments, frequency bin values of the set of output audio signals may be determined by a matrix multiplication of the frequency bin values of the set of input audio signals by a weight matrix. The weight matrix may include the first weight and the second weight. The weight matrix may have weights for contributions to output audio signals from linked input audio signals on the diagonal. The weight matrix may have weights for contributions to output audio signals from non-linked input audio signals outside the diagonal. The adapter may be arranged to constrain the weight matrix to be a Hermitian matrix.

In accordance with an optional feature of the invention, the adapter is arranged to update the first weight in response to a product of a first value and a second value, the first value being one of the first previous frequency bin value and the second previous frequency bin value and the second value being a complex conjugate of the other of the first previous frequency bin value and the second previous frequency bin value.

This may provide improved performance and/or operation in many embodiments. It may typically provide improved adaptation leading to increased decorrelation of the output audio signals in many scenarios.

The adapter is arranged to update a second weight being for a contribution to the first frequency bin value from a third frequency bin value being a frequency bin value of the first frequency bin for the first input audio signal in response to a magnitude of the first previous frequency bin value.

This may provide improved performance and/or operation in many embodiments. It may typically provide improved adaptation leading to increased decorrelation of the output audio signals in many scenarios. It may in particular provide an improved adaptation of the generated output signals. In many embodiments, the updating of the weight reflecting the contribution to an output signal from the linked input signal may be dependent on the signal magnitude/amplitude of that linked input signal. For example, the updating may seek to compensate the weight for the level of the input signal to generate a normalized output signal.

The approach may allow a normalization/signal compensation/level compensation to provide e.g., a desired output level.

In accordance with an optional feature of the invention, the adapter is arranged to constrain a weight for a contribution to the first frequency bin value from a third frequency bin value being a frequency bin value of the first frequency bin for the first input audio signal to be a real value.

This may provide improved performance and/or operation in many embodiments. It may typically provide improved adaptation leading to increased decorrelation of the output audio signals in many scenarios.

The weights between linked input/output signals may advantageously be determined as/constrained to be a real valued weight. This may lead to improved performance and adaptation ensuring convergence on a non-zero level solution.

In accordance with an optional feature of the invention, the adapter is arranged to set a third weight being a weight for a contribution to a fourth frequency bin value of the first frequency bin for the second output audio signal from the first input audio signal to be a complex conjugate of the first weight.

This may provide improved performance and/or operation in many embodiments. It may typically provide improved adaptation leading to increased decorrelation of the output audio signals in many scenarios.

The two weights for two pairs of input/output signals may be complex conjugates of each other in many embodiments.

In accordance with an optional feature of the invention, weights of the weighted combination for other input audio signals than the first input audio signal are complex valued weights.

This may provide improved performance and/or operation in many embodiments. The use of complex values for weights for non-linked input signals provide an improved frequency domain operation.

In accordance with an optional feature of the invention, the adapter is arranged to determine output bin values for the given frequency bin ω from:

y(ω)=W(ω)x(ω)
where y(ω) is a vector comprising the frequency bin values for the output audio signals for the given frequency bin ω; x(ω) is a vector comprising the frequency bin values for the input audio signals for the given frequency bin ω; and W(ω) is a matrix having rows comprising weights of a weighted combination for the output audio signals.

This may provide improved performance and/or operation in many embodiments. It may typically provide improved adaptation leading to increased decorrelation of the output audio signals in many scenarios.

The matrix W(ω) may advantageously be Hermitian. In many embodiments, the diagonal of the matrix W(ω) may be constrained to be real values, may be set to a predetermined value(s), and/or may not be updated/adapted but may be maintained as a fixed value. The weights/coefficients outside the diagonal may generally be complex values.

In accordance with an optional feature of the invention, the adapter is arranged to adapt weights wᵢⱼ of the matrix W(ω) according to:

wᵢⱼ(k+1,ω)=wᵢⱼ(k,ω)−η(k,ω)[yᵢ(k,ω)y*ⱼ(k,ω)]
where i is a row index of the matrix W(ω), j is a column index of the matrix W(ω), k is a time segment index, ω represents the frequency bin, and η(k, ω) is a scaling parameter for adapting an adaptation speed.

This may provide improved performance and/or operation in many embodiments. It may typically provide improved adaptation leading to increased decorrelation of the output audio signals in many scenarios.

In accordance with an optional feature of the invention, the adapter is arranged to compensate the correlation value for a signal level of the first frequency bin.

This may provide improved performance and/or operation in many embodiments. It may typically provide improved adaptation leading to increased decorrelation of the output audio signals in many scenarios. It may allow a compensation of the update rate for signal variations.

In accordance with an optional feature of the invention, the adapter is arranged to initialize the weights for the weighted combination to comprise at least one zero value weight and one non-zero value weight.

This may provide improved performance and/or operation in many embodiments. It may typically provide improved adaptation leading to increased decorrelation of the output audio signals in many scenarios. It may allow a more efficient and/or quicker adaptation and convergence towards advantageous decorrelation. In many embodiments, the matrix W (ω) may be initialized with zero values for weights or coefficients for nonlinked signals and fixed non-zero real values for linked signals. Typically, the weights may be set to e.g., 1 for weights on the diagonal and all other weights may initially be set to zero.

In accordance with an optional feature of the invention, the weighted combination comprises applying a time domain windowing to a frequency representation of weights formed by weights for the first input audio signal and the second input audio signal for different frequency bins.

This may provide improved performance and/or operation in many embodiments. It may typically provide improved adaptation leading to increased decorrelation of the output audio signals in many scenarios.

Applying the time domain windowing to the frequency representation of weights may comprise: converting the frequency representation of weights to a time domain representation of weights; applying a window to the time domain representation to generate a modified time domain representation; and converting the modified time domain representation to the frequency domain.

In accordance with an optional feature of the invention, the audio apparatus further comprises: an audio beamformer arranged to receive the set of output audio signals and to perform an audio beamforming to generate a beamformed audio output signal.

In accordance with an optional feature of the invention, the audio beamforming is an adaptive audio beamforming.

According to an aspect of the invention, there is provided a method of generating a set of output audio signals being decorrelated signals of a set of input audio signals: receiving the set of input audio signals; segmenting the set of input audio signals into time segments; generating the set of output audio signals, each output audio signal of the set of output audio signals being linked with one input audio signal of the set of input audio signals, wherein generating the set of output audio signals comprises for each time segment performing the steps of: generating a frequency bin representation of the set of input audio signals, each frequency bin of the frequency bin representation of the set of input audio signals comprising a frequency bin value for each of the input audio signals of the set of input audio signals; generating a frequency bin representation of the set of output audio signals, each frequency bin of the frequency bin representation of a set of output audio signals comprising a frequency bin value for each of the output audio signals, the frequency bin value for a given output audio signal of the set of output audio signals for a given frequency bin being generated as a weighted combination of frequency bin values of the set of input audio signals for the given frequency bin; generating a time domain representation for each output audio signal from the frequency bin representation of the set of output audio signals; and the method further comprises updating weights of the weighted combination including updating a first weight for a contribution to a first frequency bin value of a first frequency bin for a first output audio signal linked with a first input audio signal from a second frequency bin value of the first frequency bin for a second input audio signal linked to a second output audio signal in response to a correlation measure between a first previous frequency bin value of the first output audio signal for the first frequency bin and a second previous frequency bin value of the second output audio signal for the first frequency bin; and wherein updating weights of the weighted combination comprises updating a second weight being for a contribution to the first frequency bin value from a third frequency bin value being a frequency bin value of the first frequency bin for the first input audio signal in response to a magnitude of the first previous frequency bin value.

These and other aspects, features and advantages of the invention will be apparent from and elucidated with reference to the embodiment(s) described hereinafter.

### BRIEF DESCRIPTION OF THE DRAWINGS

Embodiments of the invention will be described, by way of example only, with reference to the drawings, in which

FIG. 1 illustrates an example of elements of an apparatus generating a set of output signals from a set of input signals in accordance with some embodiments of the invention;

FIG. 2 illustrates a flowchart of an example of a method of generating a set of output signals from a set of input signals in accordance with some embodiments of the invention;

FIG. 3 illustrates an example of elements of an apparatus generating a set of output signals from a set of input signals in accordance with some embodiments of the invention;

FIG. 4 illustrates an example of a signal flow for an apparatus generating a set of output signals from a set of input signals in accordance with some embodiments of the invention;

FIG. 5 illustrates an example of a signal flow for an apparatus generating a set of output signals from a set of input signals in accordance with some embodiments of the invention;

FIG. 6 illustrates an example of a signal flow for an apparatus generating a set of output signals from a set of input signals in accordance with some embodiments of the invention;

FIG. 7 illustrates an example of a signal flow for an apparatus generating a set of output signals from a set of input signals in accordance with some embodiments of the invention; and

FIG. 8 illustrates some elements of a possible arrangement of a processor for implementing elements of an audio apparatus in accordance with some embodiments of the invention.

### DETAILED DESCRIPTION OF SOME EMBODIMENTS OF THE INVENTION

The following description focuses on embodiments of the invention applicable to audio capturing such as e.g., speech capturing for a teleconferencing apparatus. However, it will be appreciated that the approach is applicable to many other audio signals, audio processing systems, and scenarios for capturing and/or processing audio.

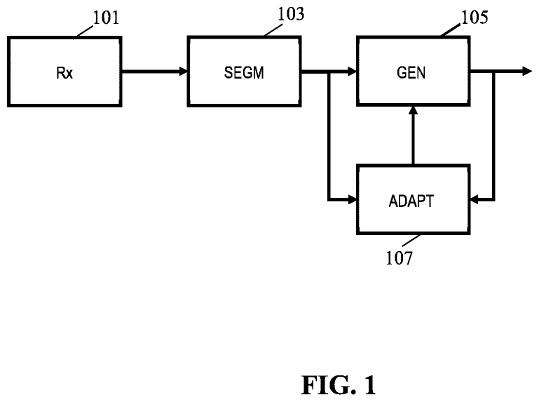

FIG. 1 illustrates an example of an audio apparatus in accordance with some embodiments of the invention.

The audio apparatus comprises a receiver 101 which is arranged to receive a set of input audio signals. The input audio signals may be received from different sources, including internal or external sources. In the following an embodiment will be described where the receiver 101 is coupled to a plurality of microphones, such as a linear array of microphones, providing a set of input audio signals in the form of microphone signals.

The input audio signals are fed to a segmenter 103 which is arranged to segment the set of input audio signals into time segments. In many embodiments, the segmentation may typically be a fixed segmentation into time segments of a fixed and equal duration such as e.g. a division into time segments/intervals with a fixed duration of between 10-20 msecs. In some embodiments, the segmentation may be adaptive for the segments to have a varying duration. For example, the input audio signals may have a varying sample rate and the segments may be determined to comprise a fixed number of samples.

The segmenter 103 is coupled to an audio signal generator 105 which is arranged to generate a set of output audio signals from the input audio signals. In many embodiments, the audio signal generator 105 is arranged to generate the same number of output signals as there are input signals, but it is possible in some embodiments for a different number of output audio signals to be generated.

The segmentation may typically be into segments with a given fixed number of time domain samples of the input signals. For example, in many embodiments, the segmenter 103 may be arranged to divide the input signals into consecutive segments of e.g., 256 or 512 samples.

The audio signal generator 105 seeks to generate the output signals to correspond to the input signals but with an increased decorrelation of the signals. The output audio signals are generated to have an increased spatial decorrelation with the cross correlation between audio signals being lower for the output audio signals than for the input audio signals. Specifically, the output signals may be generated to have the same combined energy/power as the combined energy/power of the input signals (or have a given scaling of this) but with an increased decorrelation (decreased correlation) between the signals. Thus, the output signals may specifically be generated to have decreased coherence (correlation normalized by energy/power) than the input signals.

The output audio signals may be generated to include all the audio/signal components of the input signals in the output audio signals but with a re-distribution to different signals to achieve increased decorrelation/decreased coherence.

Each output signal may be created by subtracting/removing correlated source audio components in the input signals from the scaled linked input signal leading to output signals that contain all sources, but show a reduction in mutual correlation.

Spatial correlation between the input signals may mean that a common (but unknown) signal component can be identified that differs per input signal in amplitude and/or phase. Reducing the correlation at the output may be realized by adding amplitude and/or phase modified input signals from the scaled linked input such that the common input signal component is reduced.

The audio signal generator 105 is arranged to perform an adaptive spatial decorrelation where the processing is arranged to dynamically adapt the processing and the spatial decorrelation to reflect properties of the captured audio and specifically to e.g. adapt to the acoustic environment and the relationships between the audio sources and microphone signals. Accordingly, the audio apparatus further comprises an adapter 107 which is arranged to adapt the spatial filtering.

The audio signal generator 105 may typically be arranged to apply a frequency domain based cross-signal spatial filtering to the input signals to generate the audio signals with the coefficients of the filtering being adapted based on signal properties, and specifically based on signal properties of the output signals. In particular, for each segment, a set of input signal samples may be converted into a set of output signal samples based on a spatial filtering, and a set of update values for the spatial filtering may be determined by the adapter 107. The spatial filtering is then updated for the next segment based on the update values.

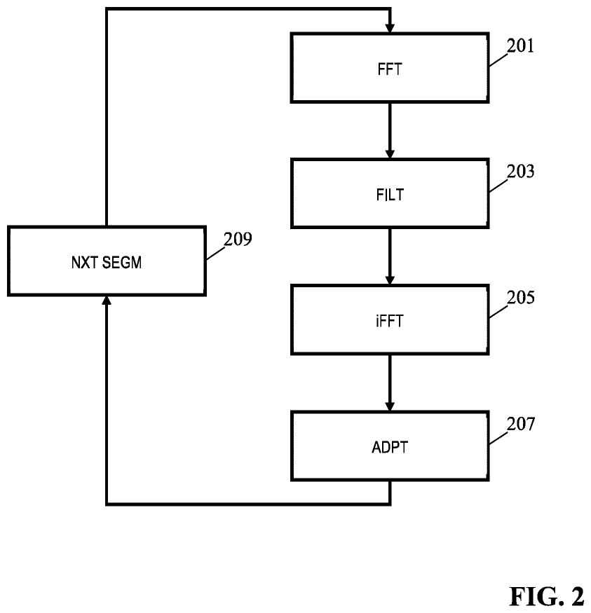

FIG. 2 illustrates a method that may be performed by the audio signal generator 105.

In step 201, the audio signal generator 105 is arranged to generate a frequency bin representation of the set of input audio signals. The audio signal generator 105 is arranged to perform a frequency domain processing of a frequency domain representation of the input audio signals. The signal representation and processing are based on frequency bins and thus the signals are represented by values of frequency bins and these values are processed to generate frequency bin values of the output signals. In many embodiments, the frequency bins have the same size, and thus cover frequency intervals of the same size. However, in other embodiments, frequency bins may have different bandwidths, and for example a perceptually weighted bin frequency interval may be used.

In some embodiments, the input audio signals may already be provided in a frequency representation and no further processing or operation is required. In some such cases, however, a rearrangement into suitable segment representations may be desired, including e.g. using interpolation between frequency values to align the frequency representation to the time segments.

In other embodiments, a filter bank, such as a Quadrature Mirror Filter, QMF, may be applied to the time domain input signals to generate the frequency bin representation. However, in many embodiments, a Discrete Fourier Transform (DFT) and specifically a Fast Fourier Transform, (FFT) may be applied to generate the frequency representation.

Step 201 is followed by step 203 in which the audio signal generator 105 generates a frequency bin representation of the set of output signals. The processing of the input signals is typically performed in the frequency domain and for each frequency bin, an output frequency bin value is generated from one or more input frequency bin values of one or more input signals as will be described in more detail in the following. The output signals are generated to (typically/on average) reduce the correlation between signals relative to the correlation of the input signals.

The audio signal generator 105 is arranged to filter the input audio signals. The filtering is a spatial filtering in that for a given output signal, the output value is determined from a plurality of, and typically all of the input audio signals (for the same time/segment and for the same frequency bin). The spatial filtering is specifically performed on a frequency bin basis such that a frequency bin value for a given frequency bin of an output signal is generated from the frequency bin values of the input signals for that frequency bin. The filtering/weighted combination is across the signals rather than being a typical time/frequency filtering.

Specifically, the frequency bin value for a given frequency bin is determined as the weighted combination of the frequency bin values of the input signals for that frequency bin. The combination may specifically be a summation and the frequency bin value may be determined as a weighted summation of the frequency bin values of the input signals for that frequency bin. The determination of a bin value for a given frequency bin may be determined as the vector multiplication of a vector of the weights/coefficients of the weighted summation and a vector comprising the bin values of the input signals:

$$[ y ] = [ {w}_{1} {w}_{2} {w}_{3} ] [ \begin{matrix}{x}_{1} \\ {x}_{2} \\ {x}_{3}\end{matrix} ]$$

where y is the output bin value, w₁-w₃ are the weights of the weighted combination, and x₁-x₃ are the input signal bin values.

Representing the output bin values for a given frequency bin ω as a vector y(ω), the determination of the output signals may be determined as:

y(ω)=W(ω)x(ω)
where the matrix W(ω) represents the weights/coefficients of the weighted summation for the different output signals and x(ω) is a vector comprising the input signal values.

For example, for an example with only three input signals and output signals, the output bin values for the frequency bin ω may be given by

$$[ \begin{matrix}{y}_{1} \\ {y}_{2} \\ {y}_{3}\end{matrix} ] = [ \begin{matrix}{w}_{11} & {w}_{12} & {w}_{13} \\ {w}_{21} & {w}_{22} & {w}_{23} \\ {w}_{31} & {w}_{32} & {w}_{33}\end{matrix} ] [ \begin{matrix}{x}_{1} \\ {x}_{2} \\ {x}_{3}\end{matrix} ]$$

where yₙ represents the output bin values, wᵢⱼ represents the weights of the weighted combinations, and xₘ represents the input signal bin values.

Step 203 is followed by step 205 in which a time domain representation of each output signal is generated from the frequency bin representation of the output signals as generated in step 203.

Typically, the reverse operation of the conversion from the time domain to the frequency domain is applied, e.g. an IFFT or iQMF operation is performed. The resulting output is accordingly a set of time domain output signals that represents the audio of the input audio signals but with increased decorrelation between the signals.

Step 205 is followed by step 207 wherein the adapter 107 is arranged to determine update values for the weights of the weighted combination(s). Thus, specifically, in step 207, update values may be determined for the matrix W(ω).

The method may then return to step 201 via step 209 to process the next segment. Step 209 may initiate the processing of the next step including updating the weights of the weighted combination based on the update values.

The adapter 107 is arranged to apply an adaptation approach that determines update values which may allow the output signals to represent the audio of the input signals but with the output signals typically being more decorrelated than the input signals.

The adapter 107 is arranged to use a specific approach of adapting the weights based on the generated output signals. The operation is based on each output audio signal being linked with one input audio signal. The exact linking between output signals and input signals is not essential and many different (including in principle random) linkings/pairings of each output signal to an input signal may be used. However, the processing is different for a weight that reflects a contribution from an input signal that is linked to/paired with the output signal for the weight than the processing for a weight that reflects a contribution from an input signal that is not linked to/paired with the output signal for the weight. For example, in some embodiments, the weights for linked signals (i.e. for input signals that are linked to the output signal generated by the weighted combination that includes the weight) may be set to a fixed value and not updated, and/or the weights for linked signals may be restricted to be real valued weights whereas other weights are generally complex values.

The adapter 107 uses an adaptation/update approach where an update value is determined for a given weight that represents the contribution to a bin value for a given output signal from a given non-linked input signal based on a correlation measure between the output bin value for the given output signal and the output bin value for the output signal that is linked with the given (non-linked) input signal. The update value may then be applied to modify the given weight in the subsequent segment, or the update value for weight in a given segment is determined in response to two output bin values of a (and typically the immediate) prior segment, where the two output values represent respectively the input signal and the output signal to which the weight relate.

The described approach is typically applied to a plurality, and typically all, of the weights used in determining the output bin values based on a non-linked input signal. For weights relating to the input signal that is linked to the output signal for the weight, other considerations may be used, such as e.g. setting the weight to a fixed value as will be described in more detail later.

Specifically, the update value may be determined in dependence on a product of the output bin value for the weight and the complex conjugate of the output bin value linked to the input signal for the weight, or equivalently in dependence on a product of the complex conjugate of the output bin value for the weight and the output bin value linked to the input signal for the weight.

As a specific example, an update value for segment k+1 for frequency bin ω may be determined in dependence on the correlation measure given by:

[yᵢ(k,ω)y*ⱼ(k,ω)]

or equivalently by:

[y*ᵢ(k,ω)yⱼ(k,ω)]
where yᵢ(k, ω) is the output bin value for the output signal i being determined based on the weight; and yⱼ(k, ω) is the output bin value for the output signal j that is linked to the input signal from which the contribution is determined (i.e. the input signal bin value that is multiplied by the weight to determine a contribution to the output bin value for signal i).

The measure of [yᵢ(k, ω) y*ⱼ(k, ω)] (or the conjugate value) indicates the correlation of the time domain signal in the given segment. In the specific example, this value may then be used to update and adapt the weight w_{ij (k+}1,ω).

As previously mentioned, the audio signal generator 105 may be arranged to determine the output bin values for the output signals for the given frequency bin ω from:

y(ω)=W(ω)x(ω)
where y(ω) is a vector comprising the frequency bin values for the output signals for the given frequency bin ω; x(ω) is a vector comprising the frequency bin values for the input audio signals for the given frequency bin ω; and W(ω) is a matrix having rows comprising weights of a weighted combination for the output audio signals.

In the example, adapter 107 may specifically be arranged to adapt at least some of the weights wᵢⱼ of the matrix W(ω) according to:

wᵢⱼ(k+1,ω)=wᵢⱼ(k,ω)−η(k,ω)[yᵢ(k,ω)y*ⱼ(k,ω)]
where i is a row index of the matrix W(ω), j is a column index of the matrix W(ω), k is a time segment index, ω represents the frequency bin, and η(k,ω) is a scaling parameter for adapting an adaptation speed. Typically, the adapter 107 may be arranged to adapt all the weights that are not relating the input signal with the linked output signal (i.e. “cross-signal” weights).

In some embodiments, the adapter 107 may be arranged to adapt the update rate/speed of the adaptation of the weights. For example, in some embodiments, the adapter may be arranged to compensate the correlation measure for a given weight in dependence on the signal level of the output bin value to which a contribution is determined by the weight.

As a specific example, the compensation value [yᵢ (k,ω)y*ⱼ (k,ω)] may be compensated by the signal level of the output bin value, |yᵢ(k,ω)|. The compensation may for example be included to normalize the update step values to be less dependent on the signal level of the generated decorrelated signals.

In many embodiments, such a compensation or normalization may specifically be performed on a frequency bin basis, i.e. the compensation may be different in different frequency bins. This may in many scenarios improve the operation and may typically result in an improved adaptation of the weights generating the decorrelated signals.

The compensation may for example be built into the scaling parameter η(k,ω) of the previous update equation. Thus, in many embodiments, the adapter 107 may be arranged to adapt/change the scaling parameter η(k,ω) differently in different frequency bins.

In many embodiments, the arrangement of the input signal vector x(ω) the output signal vector y(ω) is such that linked signals are at the same position in the respective vectors, i.e. specifically y₁ is linked with x₁, y₂ with x₂, y₃ is with x₃, etc. In this case, the weights for the linked signals are on the diagonal of the weight matrix W(k,ω). The diagonal values may in many embodiments be set to a fixed real value, such as e.g. specifically be set to a constant value of 1.

In many embodiments, the weights/spatial filters/weighted combinations may be such that the weights for a contribution to a first output signal from a first input signal (not linked to the first output signal) is a complex conjugate of the contribution to a second output signal being linked with the first input signal from a second input signal being linked with the first input signal. Thus, the two weights for two pairs of linked input/output signals are complex conjugates.

In the example of the weights for linked input and output signals being arranged on the diagonal of the weight matrix W(ω), this results in a Hermitian matrix. Indeed, in many embodiments, the weight matrix W(ω) is a Hermitian matrix. Specifically, the coefficients/weights of the weight matrix W(ω) may meet the criterion:

wᵢⱼ=w*ⱼᵢ.

As previously mentioned, the weights for the contributions to an output signal bin value from the linked input signal (corresponding to the values of the diagonal of the weight matrix W(ω) in the specific example) are treated differently than the weights for non-linked input signals. The weights for linked input signals will in the following for brevity also be referred to as linked weights and the weights for non-linked input signals will in the following for brevity also be referred to as non-linked weights, and thus in the specific example the weight matrix W(ω) will be a Hermitian matrix comprising the linked weights on the diagonal and the non-linked weights outside the diagonal.

In many approaches, the adaptation of the non-linked weights is such that it seeks to reduce the correlation measures. Specifically, each update value may be determined to reduce the correlation measure. Overall, the adaptation will accordingly seek to reduce the cross-correlations between the output signals. However, the linked weights are determined differently to ensure that the output signals maintain a suitable audio energy/power/level. Indeed, if the linked weights where instead adapted to seek to reduce the autocorrelation of the output signal for the weight, there is a high risk that the adaptation would converge on a solution where all weights, and thus output signals, are essentially zero (as indeed this would result in the lowest correlations). Further, the audio apparatus is arranged to seek to generate signals with less cross-correlation but do not seek to reduce autocorrelation.

Thus, in many embodiments, the linked weights may be set to ensure that the output signals are generated to have a desirable (combined) energy/power/level.

In some cases, the adapter 107 may be arranged to adapt the linked weights, and in other cases the adapter may be arranged to not adapt the linked weights.

For example, in some embodiments, the linked weights may initially be set to a fixed constant value that is not adapted. For example, in many embodiments, the linked weights may be set to a constant scalar value, such as specifically to the value 1 (i.e. a unitary gain being applied for a linked input signal). For example, the weights on the diagonal of the weight matrix W(ω) may be set to 1.

Thus, in many embodiments, the weight for a contribution to a given output signal frequency bin value from a linked input signal frequency bin value may be set to a predetermined value.

Such an approach has been found to provide very efficient performance and may result in an overall adaptation that has been found to provide output signals to be generated that provide a highly accurate representation of the original audio of the input signals but in a set of output signals that have increased decorrelation.

The linked weights are adapted but are adapted differently than the non-linked weights. In particular, in many embodiments, the linked weights may be adapted based on the output signals.

In particular, a linked weight for a first input signal and linked output signal is adapted based on the generated output bin value of the linked audio signal, and specifically based on the magnitude of the output bin value.

In many embodiments, the adapter 107 may be arranged to determine the magnitude of each (or at least one or some) of the output audio signals. It may then proceed to adapt the weight for the linked input/output signal based on the determined magnitude for that output audio signal.

Specifically, for a given output bin value for a given output audio signal, the adapter 107 may proceed to determine a parameter indicative of the magnitude for the values of that bin. The adapter 211 may then further be arranged to generate an update value for the weight for that bin with weight being for the contribution to that output signal/bin from the linked input signal/bin.

In this way, the adapter 211 may be arranged to update a weight for a contribution to a given output signal bin value from a bin value (for the same frequency bin) of the linked input signal in response to/dependence on/as a function of the magnitude of previous bin values for the (same frequency bin and) the (linked) output audio signal.

For a weight matrix W(ω) where the linked weights reflecting the contribution to an output audio signal from the linked audio input signal are on the diagonal and with cross signal weights reflecting a contribution to an output audio signal from a non-linked input audio signal are off the diagonal, the adapter 107 may be arranged to update one or more of the coefficients of the diagonal in dependence/as a function of the magnitude of previous values of that audio output signal. The update operation is performed on a frequency bin/time segment basis and thus each bin value may be determined on previous output values of that frequency bin only.

In the approach, one or more of the diagonal coefficients may accordingly be updated based on the magnitude of previous output audio signal bin values calculated for that audio output signal and bin. As an example, the weight matrix may be initialized with predetermined weights on the diagonal. The adapter 107 may then proceed to adapt some or often all diagonal weights based on the magnitude of the generated output bin values for the corresponding output audio signal.

In some cases, e.g. one diagonal weight may be kept constant or set dependent on other considerations. For example, one diagonal weight may be set to a fixed value (say to unity) or may be set to provide a desired overall gain (e.g. set dependent on the overall captured audio energy to provide an automatic gain/level adjustment). The adaptation of the rest of the coefficients may then be in reference to this value resulting in a generation of decorrelated signals with a suitable overall signal level. Such an approach may for example allow a normalization and/or setting of the desired energy level for the signals.

In many embodiments, the linked weights are constrained to be real valued weights whereas the non-linked weights are generally complex values. In particular, in many embodiments, the weight matrix W(ω) may be a Hermitian matrix with real values on the diagonal and with complex values outside of the diagonal.

Such an approach may provide a particular advantageous operation and adaptation in many scenarios and embodiments. It has been found to provide a highly efficient spatial decorrelation while maintaining a relatively low complexity and computational resource.

The adaptation may gradually adapt the weights to increase the decorrelation between signals. In many embodiments, the adaptation may be arranged to converge towards a suitable weight matrix W(ω) regardless of the initial values and indeed in some cases the adaptation may be initialized by random values for the weights.

However, in many embodiments, the adaptation may be started with advantageous initial values that may e.g. result in faster adaptation and/or result in the adaptation being more likely to converge towards more optimal weights for decorrelating signals.

In particular, in many embodiments, the weight matrix W(ω) may be arranged with a number of weights being zero but at least some weights being non-zero. In many embodiments, the number of weights being substantially zero may be no less than 2,3,5, or 10 times the number of weights that are set to a non-zero value. This has been found to tend to provide improved adaptation in many scenarios.

In particular, in many embodiments, the adapter 107 may be arranged to initialize the weights with linked weights being set to a non-zero value, such as typically a predetermined non-zero real value, whereas non-linked weights are set to substantially zero. Thus, in the above example where linked signals are arranged at the same positions in the vectors, this will result in an initial weight matrix W(ω) having non-zero values on the diagonal and (substantially) zero values outside of the diagonal.

Such initializations may provide particularly advantageous performance in many embodiments and scenarios. It may reflect that due to the audio signals typically representing audio at different positions, there is a tendency for the input signals to be somewhat decorrelated. Accordingly, a starting point that assumes the input signals are fully correlated is often advantageous and will lead to a faster and often improved adaptation.

It will be appreciated that the weights, and specifically the non-linked weights, may not necessarily be exactly zero but may in some embodiments be set to low values close to zero. However, the initial non-zero values may be at least 5,10,20 or 100 times higher than the initially substantially zero values.

The described approach may provide a highly efficient adaptive spatial decorrelator that may generate output signals that represent the same audio as the input signals but with increased decorrelation. The approach has in practice been found to provide a highly efficient adaptation in a wide variety of scenarios and in many different acoustic environments and for many different audio sources. For example, it has been found to provide a highly efficient decorrelation of speaker signals in environments with multiple speakers.

The adaptation approach is furthermore computationally efficient and in particular allows localized and individual adaptation of individual weights based only on two signals (and specifically on only two frequency bin values) closely related to the weight, yet the process results in an efficient and often substantially optimized global optimization of the spatial filtering, and specifically the weight matrix W(ω). The local adaptation has been found to lead to a highly advantageous global adaptation in many embodiments.

A particular advantage of the approach is that it may be used to decorrelate convolutive mixtures and is not limited to only decorrelate instantaneous mixtures. For a convolutive mixture, the full impulse response determines how the signals from the different audio sources combine at the microphones (i.e. the delay/timing characteristics are significant) whereas for instantaneous mixes a scalar representation is sufficient to determine how the audio sources combine at the microphones (i.e. the delay/timing characteristics are not significant). By transforming a convolutive mixture into the frequency domain, the mixture can be considered a complex-valued instantaneous mixture per frequency bin.

In the following a more detailed and mathematical description of an example of a spatial decorrelator following some or all of the above described principles will be provided. In the example, linked input signals and output signals are denoted by the same index and position in the input and output vectors x(ω), y(ω) and a de-mixing/weight matrix W(ω) is determined for which the linked weights are on the diagonal.

The exemplary adaptive spatial decorrelator (SDC) works in the frequency domain, and a robust simple learning rule is applied for each single frequency bin to achieve decorrelation for that frequency bin. Yet, the individual and local adaptation results in an overall adaptation of the spatial decorrelation.

A solution in the frequency domain has the advantage that convolutions and correlations in time domain are replaced by element-wise multiplications. Significantly, a frequency domain approach as described may also allow convolutive mixtures to be considered instantaneous mixtures (per frequency bin) in the frequency domain.

If we consider input signals being received from a microphone array with Nmics microphones, a single noise point interferer s(ω), transfer functions hᵢ(ω) and microphone signals xᵢ(ω), with i the microphone number, we can write:

xᵢ(ω)=hᵢ(ω)s(ω)

For a pair of microphones p and q we can now write for the cross power spectrum (the frequency domain equivalent of the cross-correlation):

$${C}_{pq} ( ω ) = 𝔼 \{ {x}_{p} ( ω ) {x}_{q}^{*} ( ω ) \} ,$$

with (·)* the conjugate operator.

Let s(k) be white again, with for all ω:

Cₛₛ(ω)=E{s(ω)s*(ω)}=1

We can rewrite C_{pq}(ω) as:

$${C}_{pq} ( ω ) = 𝔼 \{ {h}_{p} ( ω ) s ( ω ) {s}^{*} ( ω ) {h}_{q}^{*} ( ω ) \} = 𝔼 \{ s ( ω ) {s}^{*} ( ω ) \} {h}_{p} ( ω ) {h}_{q}^{*} ( ω ) = {h}_{p} ( ω ) {h}_{q}^{*} ( ω ) \qquad ( Eq . 1 )$$

More generally, for a convolutive mixture with nmics sources we get, using matrix notation with

s(ω)=(s₁(ω) . . . s_{nmics}(ω))^{T} and x(ω)=(x₁(ω) . . . x_{nmics}(ω))^{T}: x(ω)=H(ω)s(ω),
where H(ω) is the so-called nmics x nsources mixing matrix.

Now we can determine an nmics x nmics covariance matrix Rₓₓ(ω) defined as:

Rₓₓ(ω)= [symbol] {x(ω)x^{H}(ω)},
with H conjugate transpose.

The microphone signals xᵢ(ω) are uncorrelated, if and only if the off-diagonal elements of Rₓₓ(ω) are all zero. When correlated, with non-zero off-diagonal elements, we need a transformation that transforms x(ω) such, that the output signals are decorrelated. This can be done with an nmics x nmics de-mixing matrix W(ω) such that the output

y(ω)=W(ω)x(ω),
has a covariance matrix R_{yy}(ω) defined as:

R_{yy}(ω)= [symbol] {y(ω)y^{H}(ω)},
with all off-diagonal elements equal to zero.

We can rewrite R_{yy}(ω) as:

$${R}_{yy} ( ω ) = 𝔼 \{ W ( ω ) x ( ω ) {x}^{H} ( ω ) {W}^{H} ( ω ) \} = W ( ω ) {R}_{xx} ( ω ) {W}^{H} ( ω ) = Λ ( ω ) ,$$

with Λ(ω) a diagonal matrix with elements λ₁(ω) . . . Δ_{nmics} (ω) that are real. Often Λ(ω) is chosen as Λ(ω)=I, the identity matrix. While this is a good choice, when you have multiple input choices sᵢ(ω), this is not the best choice when you have a single, or a dominant input noise source.

From the above, we have for the (ij)'th element of Rₓₓ(ω) for a single source s(ω):

$${r}_{xx , ij} ( ω ) = 𝔼 \{ s ( ω ) {s}^{*} ( ω ) \} {h}_{i} ( ω ) {h}_{j}^{*} ( ω ) = {ρ}_{ss}^{2} ( ω ) {h}_{i} ( ω ) {h}_{j}^{*} ( ω )$$

We introduce

$${R}_{xx} ( ω ) = {ρ}_{ss}^{2} {\tilde{R}}_{xx} ( ω ) ,$$

with \tilde{R}ₓₓ(ω) the coherence matrix, a normalized covariance matrix. The elements of \tilde{R}ₓₓ(ω) only depend on the transfer functions h_{i,j}(ω), not on the signal characteristics of the source s(ω). This means that with W(ω)\tilde{R}ₓₓ(ω)W^{H}(ω)=I, also W(ω) will only depend on the transfer functions h_{i,j}(ω). This is advantageous, since the changes in the acoustic paths are normally much slower, when compared to the changes in the spectrum of the noise source (assuming non-stationarity). Since we will not use the coherence matrix directly, we will get the same effect if we choose

$$Λ ( ω ) = {ρ}_{s s}^{2} ( ω ) I ,$$

since.

$${R}_{yy} ( ω ) = W ( ω ) {R}_{xx} ( ω ) {W}^{H} ( ω ) = {ρ}_{ss}^{2} ( ω ) W ( ω ) {\tilde{R}}_{xx} ( ω ) {W}^{H} ( ω ) = {ρ}_{ss}^{2} I$$

Later-on, we will see that the update rule is simplified when we choose

$$Λ ( ω ) = α ( ω ) {ρ}_{ss}^{2} ( ω ) I ,$$

with α(ω) a scalar independent of

$${ρ}_{ss}^{2} ( ω ) .$$

The decorrelation/weight matrix W may be symmetric positive definite. Symmetric means wᵢⱼ=wⱼᵢ and if Rₓₓ is positive definite (all eigenvalues should be positive, which is normally the case, certainly when there is some uncorrelated (sensor) noise present), then, with W symmetric, W will also be positive definite (Suppose the real positive eigenvalues are λ₁ . . . λ_{nmics}, then the eigenvalues of W are

$$\frac{1}{\sqrt{{λ}_{1}}} … \frac{1}{\sqrt{{λ}_{nmics}}} ) .$$

An adaptation/learning approach/rule may be based on the equation:

W(k+1)=W(k)+η(k)(Λ−y(k)y^{T}(k)),
or in scalar form:

wᵢⱼ(k+1)=wᵢⱼ(k)+η(k)[δᵢⱼλᵢ−yᵢ(k)yⱼ(k)]
with k the time index, η(k) the step size or learning rate, and δᵢⱼ the Kronecker symbol. This learning rule may be called a local learning rule, since for calculating wᵢⱼ (k+1) we only need the signals yᵢ(k) and yⱼ(k). Note that when at initialization W(0)=I, W(k) will be symmetric, since y(k)y^{T}(k) will be symmetric.

For a time domain based system addressing instantaneous mixtures with real signal values similar approaches have been indicated in A. Cichocki and S. Amari, “Adaptive Blind Signal and Image Processing”, Chichester (West ussex, England): John Wiley & Sons, Ltd, 2002.

For the learning rule in the frequency domain, complex numbers should preferably be used instead of real values. To apply the local learning rule the matrix W(ω) is preferably Hermitian,

$${w}_{i j} ( ω ) = {w}_{j i}^{*} ( ω ) .$$

Since Rₓₓ(ω) is also Hermitian and positive definite, with positive real eigenvalues, W(ω) will also be positive definite, and the learning rule for complex numbers can be applied:

W(k+1,ω)=W(k,ω)+η(k)(Λ−y(k,ω)y^{H}(k,ω)),
or in scalar form:

$${w}_{i j} ( k + 1 , ω ) = {w}_{i j} ( k , ω ) + η ( k ) [ {δ}_{i j} {λ}_{i} - {y}_{i} ( k , ω ) {y}_{j}^{*} ( k , ω ) ] \qquad ( Equation 1 )$$

Note than when W(0,ω))=I, W(k+1,ω) remains Hermitian, since y(k,ω)y^{H} (k,ω) is Hermitian.

Here k is the frame index. Block/segment processing can be used where the time data is divided into blocks or frames of e.g. 256 points before each block or frame is being transformed to the frequency domain.

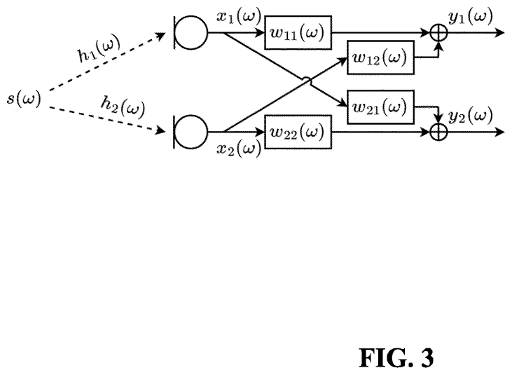

To understand some further aspects of this solution, we will take as an example a two microphone solution as illustrated in FIG. 3. We will start with a point noise source s(ω), with transfer functions h₁(ω) and h₂(ω), a 2×2 matrix W and outputs y₁(ω) and y₂(ω).

We initialize W(0,ω)=I, and for the moment do not update w₁₁(ω) and w₂₂(ω) Further, we assume [symbol] {s(k,ω)s*(k,ω)}=1, for all k and ω. We frequently use

$${w}_{21} ( k , ω ) = {w}_{12}^{*} ( k , ω ) .$$

If we look at the expected gradient [symbol] {∇w₁₂(k,ω)} we have:

$$𝔼 \{ ∇ {w}_{12} ( k , ω ) \} = 𝔼 \{ {y}_{1} ( k , ω ) {y}_{2}^{*} ( k , ω ) \} = 𝔼 \{ ( {x}_{1} ( k , ω ) + {w}_{12} ( k , ω ) {x}_{2} ( k , ω ) ) ( {x}_{2}^{*} ( k , ω ) + {w}_{21}^{*} ( k , ω ) {x}_{1}^{*} ( k , ω ) ) \} = ( {h}_{1} ( ω ) + {w}_{12} ( k , ω ) {h}_{2} ( ω ) ) ( {h}_{2}^{*} ( ω ) + {w}_{21}^{*} ( k , ω ) {h}_{1}^{*} ( ω ) ) 𝔼 \{ s ( k , ω ) {s}^{*} ( k , ω ) \} = ( {h}_{1} ( ω ) + {w}_{12} ( k , ω ) {h}_{2} ( ω ) ) ( {h}_{2}^{*} ( ω ) + {w}_{21}^{*} ( k , ω ) {h}_{1}^{*} ( ω ) )$$

For [symbol] {∇w₁₂(k,ω)}=0 we have two solutions:

$${w}_{12} ( k , ω ) = - \frac{{h}_{1} ( ω )}{{h}_{2} ( ω )} and$$

$${w}_{21} ( k , ω ) = - \frac{{h}_{2} ( ω )}{{h}_{1} ( ω )}$$

The amplitudes of the two solutions are the inverse of each other, so we will always have a solution with amplitude smaller or equal to one.

It can be shown that with the adaptation approach above, we find the solution with the smallest amplitude, and that this solution is stable, except for |h₁(ω)|=|h₂(ω)|, when in (Eq. 2) both terms become zero. The same is true (with |h₁(ω)|<|h₂(ω)|) when we choose

$${w}_{22} ( ω ) = \frac{{\vert {h}_{1} ( ω ) \vert}^{2}}{{\vert {h}_{2} ( ω ) \vert}^{2}}$$

The righthand side of (Eq. 2) then can be written as:

$${w}_{22}^{*} ( ω ) {h}_{2}^{*} ( ω ) + {w}_{21}^{*} ( k , ω ) {h}_{1}^{*} ( ω )$$

and will become zero if

$${w}_{12} ( k , ω ) = {w}_{21}^{*} ( k , ω ) = - \frac{{h}_{1} ( ω )}{{h}_{2} ( ω )}$$

This solution is typically not stable.

Stability issues may in some cases arise in case of a single point source the data correlation matrix Rₓₓ is not positive definite, but semi-positive definite instead, with eigen values that are zero. Then it may not be appropriate to use the simple local learning rule, which requires W(ω) to be positive definite. In the case with one point source, Rₓₓ only contains one non-zero eigen value that belongs to the point source. If we have additional noise sources (both correlated and uncorrelated) then Rₓₓ becomes positive definite and the simple learning rule can be applied.

In acoustic applications there will typically always be additional noise sources. Firstly, we have microphone sensor noise in each microphone. These noises are uncorrelated and have approximately equal variances. Secondly, we have remaining signal energy due to the point noise source. To understand this, we revert to time domain where we described the microphone signal as

$${x}_{i} ( k ) = {\sum }_{m = 0}^{m = ∞} s ( k - m ) {h}_{i} ( m ) ,$$

and for the example with 2 microphones above we can write for y₁(k):

$${y}_{1} ( k ) = {\sum }_{m = 0}^{m = ∞} s ( k - m ) {h}_{1} ( m ) - {\sum }_{m = 0}^{m = Nfir} {x}_{2} ( k - m ) {w}_{12} ( m ) ,$$

where w₁₂(m) is an FIR filter of length Nfir. After convergence we can write:

$${\sum }_{m = 0}^{m = Nfir} {x}_{2} ( k - m ) {w}_{12} ( m ) = {\sum }_{m = 0}^{m = Nfir} s ( k - m ) {h}_{1} ( m )$$

and rewrite y₁(k) as:

$${y}_{1} ( k ) = {\sum }_{m = 0}^{m = Nfir} s ( k - m ) {h}_{1} ( m ) + {\sum }_{m = Nfir}^{m = ∞} s ( k - m ) {h}_{1} ( m ) - {\sum }_{m = 0}^{m = Nfir} s ( k - m ) {h}_{1} ( m ) = {\sum }_{m = Nfir}^{m = ∞} s ( k - m ) {h}_{1} ( m ) ,$$

where we split x₁(k) into two parts: a part that can be dealt with by the decorrelator and a tail or diffuse part, that cannot be dealt with by the decorrelator (because of the finite FIR length).

All microphone signals i will have a tail or diffuse part, generated in the same way as the one for x₁(k), with now hᵢ(n) instead of h₁(n).

If we look at the tail powers, then we can write for a white noise point source s:

$$𝔼 \{ {x}_{i , tail}^{2} ( k ) \} = 𝔼 \{ {s}^{2} ( k ) \} {\sum }_{m = Nfir}^{m = ∞} 𝔼 \{ {h}_{i}^{2} ( m ) \}$$

The expected value

$$𝔼 \{ {h}_{i}^{2} ( m ) \} ,$$

where the expectation is now over all possible source-microphone combinations in a room with a certain reverberation time T₆₀ is given by:

$$𝔼 \{ {h}_{i}^{2} ( m ) \} = K {e}^{\frac{- m}{{F}_{s} {T}_{60}}}$$

with K a constant and Fₛ the sampling frequency.

The variance for a certain realization (impulse response between a certain source—microphone position) will be high, but due to the summation the variance of

$${\sum }_{m = Nfir}^{m = ∞} {h}_{i}^{2} ( m )$$

will be much lower. This means that as a first approximation we can assume that the contributions have equal powers.

When we have in addition to the point source uncorrelated (sensor) noise at the inputs, the off-diagonal filter in W(ω) (in our example w₁₂(ω) and w₂₁(w) cause correlation of the noise at the outputs. As a result, the solution will be different from the solution without uncorrelated noise at the inputs. It can be shown that the optimal solution, when applying the learning rule of (Eq. 1) with i≠j is given by:

$$𝔼 \{ {w}_{12 , opt} \} = - \frac{{h}_{1} ( ω )}{{h}_{2} ( ω )} ( 1 - β )$$

where β is real and 0<β≤1.

B=0, corresponds to the solution where there is no uncorrelated noise at the inputs, β=1 correponds to the solution where there is only uncorrelated noise at the inputs. This solution is stable, also for the case with |h₁(ω)|=|h₂(w)|, The reason is that with the added uncorrelated noise Rₓₓ will be positive definite and as a result, also W will be positive definite, as is required to apply our learning rule.

Now we can also change w₁₂(w) and w₂₁(w) without having stability problems.

It can be shown that when uncorrelated noise signals at the inputs have equal variances, the outputs will also have equal variances. We know that sensor noise and tail contributions can be considered as having, as a first approximation, equal variances. This means that choosing w₁₁(k,ω)=w₂₂(k,ω)=1 is a valid option. It means that the update rule can be simplified to:

$${w}_{ij} ( k + 1 , ω ) = {w}_{ij} ( k , ω ) - η ( k ) [ {y}_{i} ( k , ω ) {y}_{j}^{*} ( k , ω ) ] , \qquad ( Equation 3 )$$

with i≠j.

In use cases where the described decorrelator is combined with e.g. an adaptive beamformer this has proven to be very robust. The zeroing of the off-diagonal components in R_{yy}(ω) is often much more important than having equal elements in Λ(ω). Note that when the tail contributions, that scale linearly with the source strength s(ω) are dominant over the sensor noise, the solution is only determined by the acoustic impulse responses and does not depend on the signal characteristics of the source. Since the variations in the acoustic paths are much slower when compared with the variations in the source spectrum or source amplitudes, it means that the SDC can converge to a stable solution.

For the use case with a single point source and the tails dominating the sensor noise and we want to equalize the elements in Λ(ω) such that we can write

$$Λ ( ω ) = α ( ω ) {ρ}_{s s}^{2} ( ω ) I ,$$

with α(ω) not depending on s(ω), we can follow the following procedure:

First the average power is determined, weighted by the squared inverse of wᵢᵢ:

$${P}_{avg} ( ω ) = {\sum }_{i = 0}^{i = Nmics - 1} \frac{{P}_{{y}_{i}} ( ω )}{{w}_{ii}^{2} ( ω )}$$

with P_{y}_{ᵢ}(ω) the power of output i calculated as

$${y}_{i} ( ω ) {y}_{i}^{*} ( ω )$$

Next an update of wᵢᵢ is calculated:

$${w}_{ii} ( k + 1 , ω ) = ( 1 - β ) {w}_{ii} ( k , ω ) + β \sqrt{\frac{{P}_{avg} ( ω )}{{P}_{{y}_{i}} ( ω )}} ,$$

β is a small smoothing parameter, such that the updates of the off-diagonal weights wᵢⱼ with i≠j can easily track the changes in wᵢᵢ.

In many embodiments, instead of choosing a pre-defined diagonal matrix Λ(ω), the decorrelator may be initialized with the diagonal elements of W(ω) equal to one and then the audio apparatus may proceed to not adapt these weights. In some embodiments, we may want to write

$$Λ ( ω ) = α ( ω ) {ρ}_{ss}^{2} ( ω ) ,$$

with α(ω) independent from s(ω) to equalize the outputs. The diagonal elements of W(ω) will not generally be equal to one then.

The adaptive SDC is most efficiently implemented in the frequency domain with block processing. As a specific example, at 16 a kHz sampling frequency we may use a block/segment size of 256 points. This means that also the decorrelation will be over 256 points.

When filtering in frequency domain using FFT's resulting in discrete sampled frequencies, we have circular convolutions and circular correlations instead of linear ones.

Another aspect to consider is that the applied filters are, by definition, a-causal since

$${w}_{ij} ( ω ) = {w}_{ji}^{*} ( ω ) ,$$

which corresponds to a reversal in the time domain.

Regarding the circular versus linear convolution and correlations, techniques may be used for implementing linear convolutions and correlations in the frequency domain, using overlap-add or overlap-save techniques. An overlap-save technique for applying an FIR filter with N=B coefficients may include the following processing:
1) The input signal x(n) is partitioned in blocks/segments of B samples and concatenated with the previous block of B samples.
2) The resulting block of 2B samples is transformed to the frequency domain.
3) The impulse response of the FIR filter is extended with B zeroes, and is transformed by an FFT of size 2B to the frequency domain.
4) The outputs of the two FFTs are bin-wise multiplied, after which a 2B IFFT is applied.
5) It can be shown that the first B samples contain circular convolution artifacts, whereas the second B samples contain the result of only a linear convolution.
6) The second B samples are used as the output block.

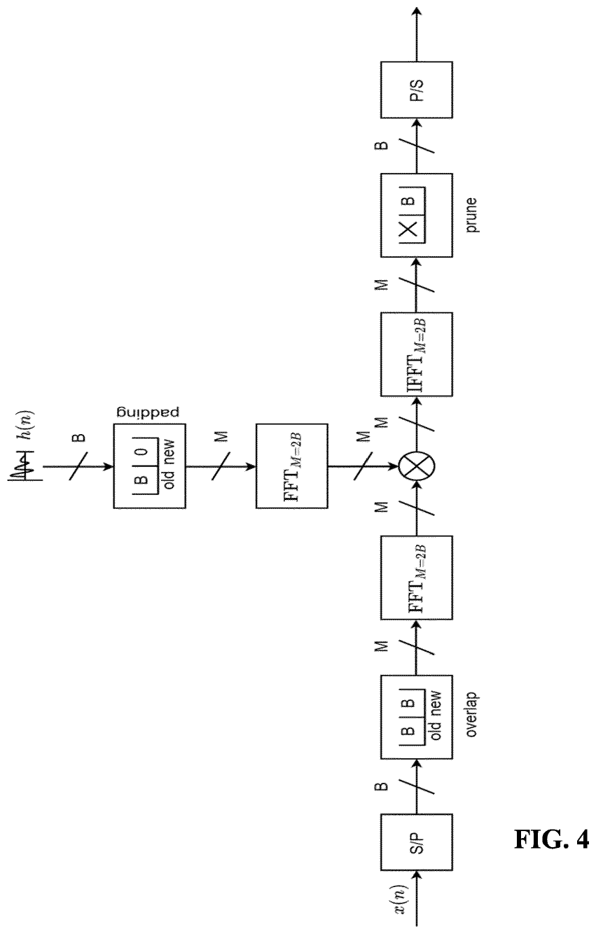

The signal flow for such an example may be as illustrated in FIG. 4. The approach may provide a linear convolution using an overlap-save technique.

We use here an overlap of 50% but other overlaps may of course be used. Suppose we have a filter length N=384 points. Then it is also possible to use a block size B=128 points and an (I)FFT of size N+B=512 points. At the input a frame of B samples must be concatenated with 3 previous blocks (overlap 75%), giving a block of 512 points, the weighting/filter vector is extended with 128 zeroes and the last 128 samples of the 512 points output is selected as the output.

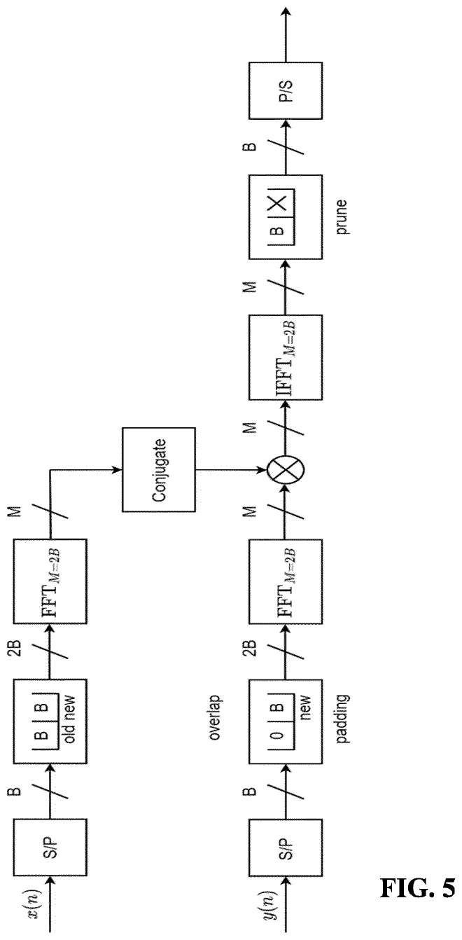

A linear correlation may be implemented similarly to the linear convolution as illustrated in FIG. 5 for an overlap of 50%.

Now suppose we have an impulse response that is a-causal and has non-zero values for |n| <N/2; In a circular representation this corresponds to a fundamental interval with

\tilde{h}(n)=h(n) and \tilde{h}(N−n)=h(−n)

Filtering with an a-causal filter in the frequency domain can then be performed as follows (with B=N):
1) The input signal x(n) is partitioned in blocks/samples of B samples and concatenated with the previous block of B samples.
2) The resulting block of 2B samples is transformed to the frequency domain.
3) Create a vector w with w(n)=h(n) for 0≤n<N/2, w(n)=0 for N/2≤n≤3N/2 and w(2N−n)=h(−n) for 0<n<N/2 and transform it to the frequency domain with a 2N point FFT.
4) The outputs of the two FFTs are bin-wise multiplied, after which a M=2N IFFT is applied.
5) It can be shown that now the first B/2 samples contain circular convolution artifacts, as well as the last B/2 samples in the block. The B points samples in the middle contain the result of only a linear convolution.
6) The B points in the middle are used as the output block.

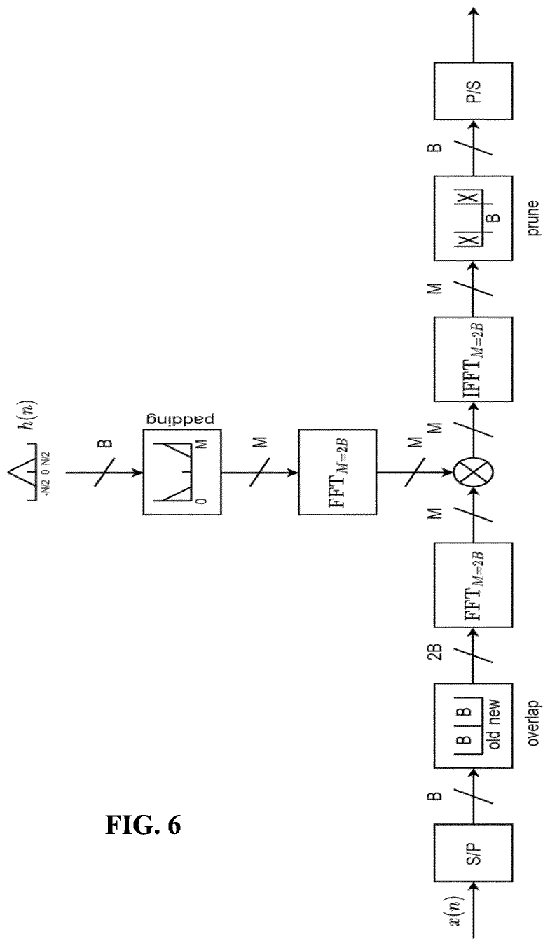

A corresponding signal flow is shown in FIG. 6.

Using such principles an adaptive spatial decorrelator can be developed with linear filtering for the outputs and circular convolutions and correlations for updating the coefficients.

We can define an nmics x nmics matrix W, where each entry wᵢⱼ consists of a (complex) frequency domain vector of M/2+1 points (we assume real input signals such that an input block of M samples gives M/2+1 unique frequency points). An element of this vector is given by: wᵢⱼ(ω). W(ω) denotes, as before, an nmics x nmics matrix for a certain frequency (bin) ω (the weight matrix W(ω)).

The main diagonal of W may consist of elements wᵢᵢ(ω)=1 for all i and ω.

The approach may specifically follow the following steps:
1) The input (microphone) signals xᵢ(n) with 0≤i<Nmics, with Nmics the number of microphones, are partitioned into frames of B samples and concatenated with a previous frame of B samples giving a block of M=2B samples
2) The Nmics blocks are transformed to frequency domain using an M-point FFT.
3) First the outputs in time domain are calculated using linear filtering. To achieve this the following steps are taken:
   a) Each frequency domain vector wᵢⱼ is transformed to the time domain, and windowed (multiplied) by a window given by:
      window(n)=1 for 0≤n<M/4
      window(n)=0 for M/4≤n<3M/4
      window(n)=1 for 3M/4≤n<M
   b) The windowed time domain vectors are transformed into frequency domain, resulting in the matrix \tilde{W}.
   c) For each frequency ω the outputs are calculated according \tilde{y}(ω)=\tilde{W}(ω)x(ω) with \tilde{y}(ω) and x(ω) column vectors of length Nmics.
   d) The resulting Nmics frequency domain vectors \tilde{y}ᵢ(ω) are converted back to the domain with an M-point IFFT.
   e) The final output frames with B samples are extracted from the converted time domain signals by:
      yᵢ(n)=\tilde{y}ᵢ(M/4+n) for M/4≤n<3M/4
4) The updates are determined as follows:
   a) For each w the outputs are calculated according y(ω)=W(ω)x(ω)

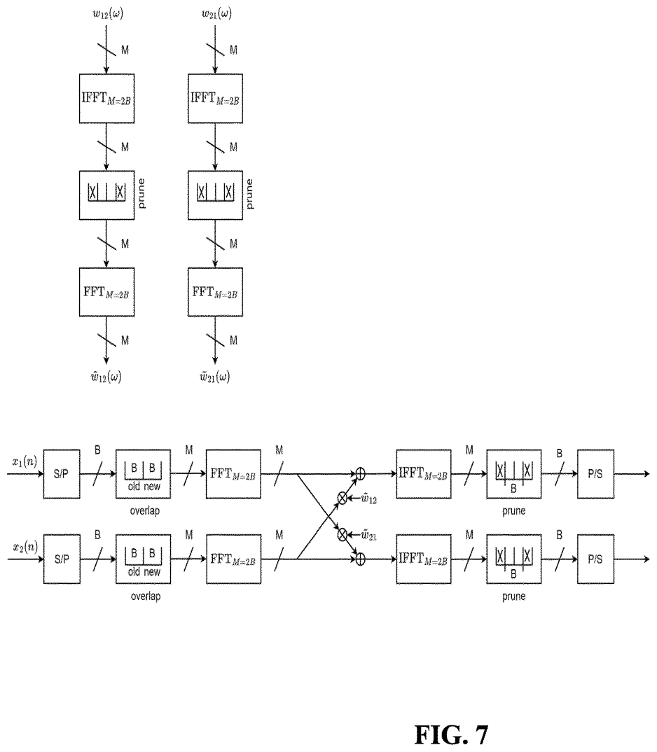

The update formula is applied for each ω:

$${w}_{ij} ( k + 1 , ω ) = {w}_{ij} ( k , ω ) - η ( k , ω ) [ {y}_{i} ( k , ω ) {y}_{j}^{*} ( k , ω ) ] ( i . j = 1 , 2 , … Nmics , i \neq j ) ,$$

where k denotes the frame index
   The steps 1-4 may be repeated for each frame/segment. An example of the operation of Steps 1-3 (the filtering/decorrelation steps) is illustrated in FIG. 7

In the specific approach, the filtering/weighted combination may thus include applying a time domain windowing to the frequency representation provided by the weights of a specific position in the weight matrix W(ω) for different frequency bins. Thus, for a given input signal and output signal, the weights for the different frequency bins form a frequency representation. The audio signal generator 105 may be arranged to generate modified weights that are used in the weighted combination/filtering by applying a time domain window.

The audio signal generator 105 may specifically take the frequency representation for a given weight (position, for a given input and output signal pair) and convert that to the time domain (e.g. using an FFT). The audio signal generator 105 may then apply a window to the time domain representation to generate a modified time domain representation. In many embodiments, the window may be such that a center portion of the segment of the time domain representation is set to (substantially) zero. The audio signal generator 105 may then convert the modified time domain representation to the frequency domain to generate modified weights. The filtering of the input signals to generate the output signals, i.e. the weighted combination, is based on the modified weights. However, the weight matrix W(ω) that is adapted and stored for future segments is unchanged. Thus, in some embodiments, the weight matrix W(ω) that is adapted is for the specific filtering modified based on the time domain windowing. Thus, for the filtering, the weight matrix W can be modified to \tilde{W}.

With respect to the learning parameter η(k,ω), the adapter 107 may apply normalization per frequency bin ω, such that the convergence speed does not depend on the (frequency) amplitudes of the inputs. For each frequency ω the audio signal generator 105 can determine the summed power of the Nmics output signals yᵢ(ω) and smooth it with a first order recursion with a time constant of 50 msec. If we call this power P_{y}(k,ω) the audio signal generator 105 can determine the update constant η(k,ω)=α/P_{y}(k,ω) with α typically smaller than 0.1.

Since

$${w}_{ij} ( ω ) = {w}_{ji}^{*} ( ω )$$

a considerable memory and complexity reduction in the update part can be obtained by storing and calculating only the values wᵢⱼ(ω) for j<i.

Apart from the considerable complexity reduction the implementation with, in the update part, circular convolutions and correlations instead of linear ones is found to be more robust, for the cases where the input is semi-positive definite (mostly in simulations).

In the following a detailed exemplary analysis is provided of the scenario of FIG. 3 with two microphone inputs and using the update rule in Equation 1.

We initialize W(0,ω)=I, and for the moment do not update w₁₁(ω) and w₂₂(ω) Further, we assume [symbol] {s(k,ω)s*(k,ω)}=1, for all k and ω. We frequently use

$${w}_{21} ( k , ω ) = {w}_{12}^{*} ( k , ω ) .$$

In case of a single point noise source, without additional noises we found that for [symbol] {∇w₁₂(k,ω)}=0 we have two solutions:

$${w}_{12} ( k , ω ) = - \frac{{h}_{1} ( ω )}{{h}_{2} ( ω )}$$

$$and$$

$${w}_{21} ( k , ω ) = - \frac{{h}_{2} ( ω )}{{h}_{1} ( ω )}$$

The amplitudes of the two solutions are the inverse of each other, so we will always have a solution with amplitude smaller or equal to one.

From now on we assume |h₂(ω)|>|h₁(ω)|, without loss of generality, since otherwise we will start with w₂₁(k,ω) instead of w₁₂(k,ω). The case |h₂(ω)|=|h₁(ω)| will be discussed later.

If we look at the first iteration with w_{1,2}(0,ω)=0 we have:

$$𝔼 \{ ∇ {w}_{12} ( k , ω ) \} = 𝔼 \{ {y}_{1} ( 0 , ω ) {y}_{2}^{*} ( 0 , ω ) \} = {h}_{1} ( ω ) {h}_{2}^{*} ( ω ) = \frac{{h}_{1} ( ω )}{{h}_{2} ( ω )} {\vert {h}_{2} ( ω ) \vert}^{2}$$

For the expected weight update we have:

$$𝔼 \{ Δ {w}_{1 , 2} ( 0 , ω ) \} = - η𝔼 \{ ∇ {w}_{12} ( 0 , ω ) \} = - η \frac{{h}_{1} ( ω )}{{h}_{2} ( ω )} {\vert {h}_{2} ( ω ) \vert}^{2}$$

The update will be in the direction of the solution −h₁(ω)/h₂(ω), that is it has the same phase and with β=η|h₂(ω)|² a small positive number we can write for y₁(1,ω):

$${y}_{1} ( 1 , ω ) = ( h 1 ( ω ) - β {h}_{1} ( ω ) ) s ( 1 , ω ) = {h}_{1} ( ω ) ( 1 - β ) s ( 1 , ω )$$

$${h}_{1} ( 1 , ω ) s ( 1 , ω )$$

and for y₂(1,ω):

$${y}_{2} ( 1 , ω ) = ( {h}_{2} ( ω ) - β \frac{{h}_{1}^{*} ( ω )}{{h}_{2}^{*} ( ω )} {h}_{1} ( ω ) ) s ( 1 , ω ) = {h}_{2} ( ω ) ( 1 - β \frac{{\vert {h}_{1} ( ω ) \vert}^{2}}{{\vert {h}_{2} ( ω ) \vert}^{2}} ) s ( 1 , ω ) = {h}_{2} ( 1 , ω ) s ( 1 , ω )$$

Compared with y₁(0,ω) and y₂(0,ω), we only see that the amplitude of h₁(1,ω) and h₂(1,ω) changes when compared with h₁(ω) and h₂(ω). Note that the amplitude h₁(1,ω) decreases faster than the amplitude of h₂(1,ω).

In next iterations of the algorithm the amplitudes of h₁(k,ω) and h₂(k,ω) decrease further until for certain k, the expected gradient will be zero and have:

$$𝔼 \{ {w}_{12} ( k , ω ) \} = - \frac{{h}_{1} ( ω )}{{h}_{2} ( ω )}$$

This solution is also a stable solution. Suppose we perturbate the solution with dw (complex) and have (omitting the k index):

$${w}_{12} ( ω ) = - \frac{{h}_{1} ( ω )}{{h}_{2} ( ω )} + dw$$

$$and$$

$${w}_{21} ( ω ) = - \frac{{h}_{1}^{*} ( ω )}{{h}_{2}^{*} ( ω )} + {dw}^{*}$$

Then we have for y₁(ω) and y₂(ω):

y₁(ω)=dw h₂(ω)s(ω)
and

$${y}_{2} ( ω ) = {h}_{2} ( ω ) ( 1 - \frac{{\vert {h}_{1} ( ω ) \vert}^{2}}{{\vert {h}_{2} ( ω ) \vert}^{2}} ) s ( ω ) + {dw}^{*} {h}_{1} ( ω ) s ( ω )$$

The expected value for the gradient is (neglecting higher order term (dw)²)

$${𝔼 \{ {y}_{1} ( ω ) {y}_{2}^{*} ( ω ) \} = dw ( {\vert {h}_{2} ( ω ) \vert}^{2} - {h}_{1} ( ω ) \vert}^{2} )$$

In the update we have

$$𝔼 \{ {w}_{12} ( k + 1 , ω ) \} = - \frac{{h}_{1} ( ω )}{{h}_{2} ( ω )} + dw - η dw ( {\vert {h}_{2} ( ω ) \vert}^{2} - {\vert {h}_{1} ( ω ) \vert}^{2} )$$

The update is in the opposite direction of dw for all dw(η(|h₂(ω)|²−|h₁(ω)|²) is positive), and thus the solution is stable.

Looking at the powers of y₁(ω) and y₂(ω) after convergence we have:

$$𝔼 \{ {y}_{1} ( ω ) {y}_{1}^{*} ( ω ) \} = 0$$

$$and$$

$$𝔼 \{ {y}_{2} ( ω ) {y}_{2}^{*} ( ω ) \} = {\vert {h}_{2} ( ω ) \vert}^{2} {( 1 - \frac{{\vert {h}_{1} ( ω ) \vert}^{2}}{{\vert {h}_{2} ( ω ) \vert}^{2}} )}^{2} 𝔼 \{ s ( ω ) {s}^{*} ( ω ) \}$$

Depending on the ratio between |h₁(ω)| and |h₂(ω)| the power of y₂(ω) also decreases, but much less than the power of y₁(ω).

This is contradictory to what we want to achieve, namely that the output powers are equal. In this scenario this is only possible if also the output power of y₂(ω) would be zero. This could be done by setting w₂₂(ω)=h₁(ω)/h₂(ω). This change does not influence the update of w₁₂(ω), but once w₁₂(ω) has found its optimal value, also the expected power of y₂(ω) will be zero. The solution is not stable however, since if we perturbate the solution as before with

$${w}_{12} ( ω ) = - \frac{{h}_{1} ( ω )}{{h}_{2} ( ω )} + dw$$

we now get

y₁(ω)=dw h₂(ω)s(ω)
and

y₂(ω)=dw*h₁(ω)s(ω)

For the expected value of the gradient:

$$𝔼 \{ {y}_{1} ( ω ) {y}_{2}^{*} ( ω ) \} = {h}_{2} ( ω ) {h}_{1}^{*} ( ω ) {( dw )}^{2} 𝔼 \{ s ( ω ) {s}^{*} ( ω ) \}$$

Now we cannot neglect the higher order term (dw)² and have for the weight:

$$𝔼 \{ {w}_{12} ( k + 1 , ω ) \} = - \frac{{h}_{1} ( ω )}{{h}_{2} ( ω )} + dw - η {h}_{2} ( ω ) {h}_{1}^{*} ( ω ) {( dw )}^{2} = - \frac{{h}_{1} ( ω )}{{h}_{2} ( ω )} + dw ( 1 - η {h}_{2} ( ω ) {h}_{1}^{*} ( ω ) dw )$$

It cannot be guaranteed that

$$\vert 1 - η {h}_{2} ( ω ) {h}_{1}^{*} ( ω ) dw \vert < 1.$$

For example with dw=−αh₁(ω)/h₂(ω), where α is a small positive number

$$\vert 1 - η {h}_{2} ( ω ) {h}_{1}^{*} ( ω ) dw \vert > 1.$$

The solution with two expected powers equal to zero is not stable. The same is true for the case |h₂(ω)|=|h₁(ω)| (and w₂₂(ω)=1) again. Also then the expected values of the power of outputs after convergence will be zero, after perturbation the higher order term (dw)² cannot be neglected and we have:

$$𝔼 \{ {w}_{12} ( k + 1 , ω ) \} = - 1 + dw ( 1 - η {\vert {h}_{1} ( ω ) \vert}^{2} dw ) ,$$

which will not be stable for dw<0.

Such stability issues may be due to that for a single point source the data correlation matrix Rₓₓ is not positive definite, but semi-positive definite instead, with eigen values that are zero. Then we are not allowed to use the simple local learning rule, which requires W(ω) to be positive definite. In the case with one point source Rₓₓ only contains one non-zero eigen value that belongs to the point source. If we have additional noise sources (both correlated and uncorrelated) then Rₓₓ becomes positive definite and the simple learning rule can be applied.

Assume that besides the single point noise source s(ω) we have additionally uncorrelated noise s₁(ω) in the first microphone and s₂(ω) in the second microphone with equal variances, i.e.

$$𝔼 \{ {s}_{1} ( ω ) {s}_{1}^{*} ( ω ) \} = 𝔼 \{ {s}_{2} ( ω ) {s}_{2}^{*} ( ω ) \} = {ρ}_{s}^{2} ( ω ) .$$

This is typical for sensor noise.

If we look at the noise contributions of s₁(ω) and s₂(ω) in the outputs of y₁(ω) and y₂(ω) then we have:

y₁(ω)=s₁(ω)+w_{1,2}(ω)s₂(ω))

y₂(ω)=s₂(ω)+w_{2,1}(ω)s₁(ω)

Because

$${w}_{2 , 1} ( ω ) = {w}_{1 , 2}^{*} ( ω ) ,$$

the powers of y₁(ω) and y₂(ω) will be equal and for the expected gradient (only due to the noise contributions) we get:

$$𝔼 \{ ∇ {w}_{12} ( k , ω ) \} = 𝔼 \{ {y}_{1} ( ω ) {y}_{2}^{*} ( ω ) \} = {w}_{12} ( ω ) ( {ρ}_{s}^{2} ( ω ) + {ρ}_{s}^{2} ( ω ) )$$

In case the point noise source s(ω) would not be present we would have for the update:

$${w}_{12} ( k + 1 , ω ) = {w}_{12} ( k , ω ) ( 1 - η ( {ρ}_{s}^{2} ( ω ) + {ρ}_{s}^{2} ( ω ) ) )$$

Thus |w₁₂ (k+1,ω)| and |w₂₁ (k+1,ω)| decrease towards zero, what is desired for uncorrelated noise.

When the point noise source s(ω) is present the optimal solution changes, since the gradient of the point noise must compensate the gradient that is due to the uncorrelated noise in the inputs.

Since the gradient due to the noise is in the direction of w₁₂(k,ω) the optimal solution will be in the direction of −h₁(ω)/h₂(ω), the optimal solution without noise (we still assume |h₂(ω)|>|h₁(ω)|)

Suppose the deviation of the optimal solution without noise is βh₁(ω)/h₂(ω). The gradient for the noise then is:

$$𝔼 \{ ∇ {w}_{12} ( k , ω ) \} = 𝔼 \{ {y}_{1} ( ω ) {y}_{2}^{*} ( ω ) \} = - \frac{{h}_{1} ( ω )}{{h}_{2} ( ω )} ( 1 - β ) ( {ρ}_{s}^{2} ( ω ) + {ρ}_{s}^{2} ( ω ) )$$

For the gradient that is due to the point source we derive:

y₁(ω)=βh₁(ω)s(ω)

$${y}_{2} ( ω ) = {h}_{2} ( ω ) ( 1 - ( 1 - β ) \frac{{\vert {h}_{1} ( ω ) \vert}^{2}}{{\vert {h}_{2} ( ω ) \vert}^{2}} ) s ( ω )$$

$$𝔼 \{ ∇ {w}_{12} ( k , ω ) \} = {h}_{1} ( ω ) {h}_{2}^{*} ( ω ) β ( 1 - ( 1 - β ) \frac{{\vert {h}_{1} ( ω ) \vert}^{2}}{{\vert {h}_{2} ( ω ) \vert}^{2}} ) 𝔼 \{ s ( ω ) {s}^{*} ( ω ) \} = \frac{{h}_{1} ( ω )}{{h}_{2} ( ω )} β {\vert {h}_{2} ( ω ) \vert}^{2} ( 1 - ( 1 - β ) \frac{{\vert {h}_{1} ( ω ) \vert}^{2}}{{\vert {h}_{2} ( ω ) \vert}^{2}} )$$

For 0<β≤1,

$$β {\vert {h}_{2} ( ω ) \vert}^{2} ( 1 - ( 1 - β ) \frac{{\vert {h}_{1} ( ω ) \vert}^{2}}{{\vert {h}_{2} ( ω ) \vert}^{2}} )$$

is positive and increases monotonically with increasing β, whereas

$$( 1 - β ) ( {ρ}_{s}^{2} ( ω ) + {ρ}_{s}^{2} ( ω ) )$$

is also positive, but decreases monotonically and is zero for β=1. This means there is a solution where the expected gradient is zero, and the solution is given by

$$𝔼 \{ {w}_{12 , opt} \} = - \frac{{h}_{1} ( ω )}{{h}_{2} ( ω )} ( 1 - β )$$

with 0<β≤1.

This solution is also stable. Suppose we perturbate the optimal solution with dw (complex values)

$${w}_{12} ( ω ) = - \frac{{h}_{1} ( ω )}{{h}_{2} ( ω )} ( 1 - β ) + dw$$

We then get for y₁(ω):

y₁(ω)=(βh₁(ω)+h₂(ω)dw)s(ω)+s₁(ω)+w₁₂(ω)s₂(ω)
and for y₂(ω):

$${y}_{2} ( ω ) = ( {h}_{2} ( ω ) ( 1 - ( 1 - β ) \frac{{\vert {h}_{1} ( ω ) \vert}^{2}}{{\vert {h}_{2} ( ω ) \vert}^{2}} ) + {dw}^{*} ( ω ) {h}_{1} ( ω ) ) s ( ω ) + {w}_{12}^{*} {s}_{1} ( ω ) + {s}_{2} ( ω )$$

For the gradient we only must consider the extra components due to dw and can neglect the higher order term (dw)²

$$\begin{matrix}𝔼 \{ ∇ {w}_{12} ( k , ω ) \} = dw {\vert {h}_{2} ( ω ) \vert}^{2} ( 1 - ( 1 - β ) \frac{{\vert {h}_{1} ( ω ) \vert}^{2}}{{\vert {h}_{2} ( ω ) \vert}^{2}} ) 𝔼 \{ s ( ω ) {s}^{*} ( ω ) \} + \\ dw ( {ρ}_{s}^{2} ( ω ) + {ρ}_{s}^{2} ( ω ) ) \\ = dw ( {\vert {h}_{2} ( ω ) \vert}^{2} ( 1 - ( 1 - β ) \frac{{\vert {h}_{1} ( ω ) \vert}^{2}}{{\vert {h}_{2} ( ω ) \vert}^{2}} ) + ( {ρ}_{s}^{2} ( ω ) + {ρ}_{s}^{2} ( ω ) )\end{matrix}$$

With 0<β≤1 the righthand side is always positive, also for |h₁(ω)|=|h₂(ω)|, such that the update

Δw₁₂(k,ω}=−η [symbol] {∇w₁₂(k,ω)},
is always opposite to dw, which guarantees stability.

The described approach may result in an advantageous generation of decorrelated audio signals, and in particular may generate decorrelated audio signals that allow improved subsequent signal processing, such as improved speech recognition etc.

In particular, the generated decorrelated audio signals may be used as input signals to a (spatial) beamformer. The generated output audio signals may be fed from the generator 105 to an audio beamformer which is arranged to generate a beamform output audio signal therefrom. An audio apparatus may thus be generated which generates a beamform output audio signal by performing a signal processing that includes spatial beamforming and spatial decorrelation of the first set of audio signals. Thus, both beamforming and decorrelation is implemented by the audio apparatus to generate a beamform output audio signal that may specifically be directed to extract or isolate a desired audio source in the audio scene. The audio beamformer may specifically be an adaptive beamformer and accordingly both the decorrelation function and the beamforming function may be adapted.

The decorrelator and subsequent audio beamformer may provide processing that achieves the effect of both a spatial decorrelation and a subsequent adaptive beamforming. The spatial decorrelation may be controlled by a set of decorrelation parameters/weights as previously described and the spatial beamforming may be based on a set of beamform parameters. The decorrelation parameters may specifically be decorrelation coefficients/weights that are arranged to generate N output signals from N input signals where each output signal is generated as a weighted combination of samples from the N input signals. The decorrelation coefficients may specifically be the weights for such weighted combinations. The beamform parameters may specifically be parameters describing or defining the combination of signals to generate the beamform output audio signal. The beamforming may include filtering a plurality of signals and combining the filters signals. The beamform parameters may specifically define the filters (and specifically be filter coefficients) and/or the combination (e.g. a weight of each signal). The audio apparatus may adapt the spatial decorrelation by adapting the decorrelation parameters, and adapt the beamform operation by adapting the beamform parameters. The operations may be performed in time segments and in the frequency domain (and the processing may specifically be performed in frequency bins).

It will be appreciated that the specific operation performed by the audio beamformer 103, and the specific decorrelation and beamform combining, will be different in different embodiments. The combination of adaptive beamformer and spatial decorrelator functions has been found to provide very good results and in particular has found to typically provide better audio source isolation/extraction than using a conventional beamformer with no decorrelation.

In some embodiments, an audio apparatus may in comprise a beamform adapter which is arranged to adapt the beamform parameters, and specifically the beamform/combination parameters determining the beamform filters may be adapted. The adaptation may be based on the generated beamform output audio signal and in many embodiments the beamform parameters are adapted to maximize the signal level of the output signal. A number of different techniques for performing adaptive spatial decorrelation and beamforming are known and may be used without detracting from the invention.

The beamform circuit/processor may perform spatial beamforming by combining the decorrelated set of audio signals with the combining depending on the set of beamform parameters. The combining may specifically include a filtering of each of the decorrelated first set of audio signals with the filter outputs then being combined by e.g. a (weighted) summation.

It will be appreciated that many different beamformer algorithms are known and that any suitable approach or algorithm may be used by the audio beamformer.

For example, the beamformer adapter may determine the cross-correlation matrix of its input signals and compute its eigenvalue decomposition and determine the eigenvectors that belong to the largest eigenvalue (principal component analysis). The eigenvectors can be used to construct the beamform parameters of the beamform circuit.

The beamformer may be arranged to receive the set of decorrelated audio signals from which a single signal is generated. The beamformer may seek to combine these decorrelated signals such that the contributions from a given audio source are combined constructively.

A beamform circuit may specifically comprises a first set of filters

$${f}_{1}^{*} ( ω ) , {f}_{2}^{*} ( ω )$$

which filters the decorrelated audio signals provided fed to the beamform circuit. Each filter is arranged to filter one of the audio signals. Further, the filters are adaptive filters that are dynamically adapted to achieve an adaptive beamforming. The first set of filters will henceforth also be referred as beamformer filters.

The audio apparatus may comprise a feedback circuit which comprises a second set of filters that generate a second set of audio signals from a filtering of the beamform output audio signal. The second set of filters will also be referred to as feedback filters. The input signals to the beamform circuit may also be referred to as beamformer input signals and the signals generated by the feedback circuit may also be referred to as feedback signals. The feedback circuit may be used as part of the adaptation of the beamform operation.

The first and second set of filters are specifically matched/linked such that for each filter of the first set (i.e. for each beamformer filter) there is a filter of the second set (i.e. a feedback filter) which has a frequency response that is the complex conjugate of the corresponding beamformer filter. Thus, the filters of the beamform circuit and the feedback circuit are adapted together such that the filter coefficients provide a complex conjugate frequency response (equivalent/corresponding to time reversed filter impulse responses).

Thus, from the beamform output audio signal, the feedback circuit generates a set of feedback signals with each feedback signal being generated from the beamform output audio signal by a time reversed/complex conjugate filtering by matching filters.

The beamform adapter may be arranged to adapt the first set of filters and the second set of filters, i.e. the beamformer filters and the feedback filters. The beamform adapter may be arranged to perform the adaptation based on a comparison of the beamformer input signals and the feedback signals. Specifically, for each matching/linked beamformer input signal and feedback signal (signals for which the beamformer filter and the feedback filter have complex conjugate frequency responses), a difference measure may be determined, and the filters of the matching filters may be adapted to reduce/minimize the difference measure.

The audio apparatus(s) may specifically be implemented in one or more suitably programmed processors. The different functional blocks may be implemented in separate processors and/or may, e.g., be implemented in the same processor. An example of a suitable processor is provided in the following.

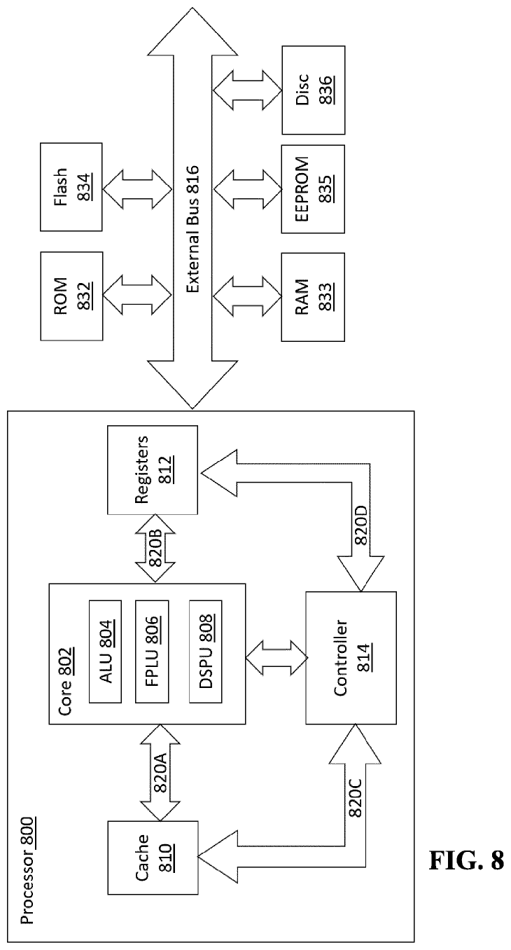

FIG. 8 is a block diagram illustrating an example processor 800 according to embodiments of the disclosure. Processor 800 may be used to implement one or more processors implementing an apparatus as previously described or elements thereof. Processor 800 may be any suitable processor type including, but not limited to, a microprocessor, a microcontroller, a Digital Signal Processor (DSP), a Field ProGrammable Array (FPGA) where the FPGA has been programmed to form a processor, a Graphical Processing Unit (GPU), an Application Specific Integrated Circuit (ASIC) where the ASIC has been designed to form a processor, or a combination thereof.

The processor 800 may include one or more cores 802. The core 802 may include one or more Arithmetic Logic Units (ALU) 804. In some embodiments, the core 802 may include a Floating Point Logic Unit (FPLU) 806 and/or a Digital Signal Processing Unit (DSPU) 808 in addition to or instead of the ALU 804.

The processor 800 may include one or more registers 812 communicatively coupled to the core 802. The registers 812 may be implemented using dedicated logic gate circuits (e.g., flip-flops) and/or any memory technology. In some embodiments the registers 812 may be implemented using static memory. The register may provide data, instructions and addresses to the core 802.

In some embodiments, processor 800 may include one or more levels of cache memory 810 communicatively coupled to the core 802. The cache memory 810 may provide computer-readable instructions to the core 802 for execution. The cache memory 810 may provide data for processing by the core 802. In some embodiments, the computer-readable instructions may have been provided to the cache memory 810 by a local memory, for example, local memory attached to the external bus 816. The cache memory 810 may be implemented with any suitable cache memory type, for example, Metal-Oxide Semiconductor (MOS) memory such as Static Random Access Memory (SRAM), Dynamic Random Access Memory (DRAM), and/or any other suitable memory technology.

The processor 800 may include a controller 814, which may control input to the processor 800 from other processors and/or components included in a system and/or outputs from the processor 800 to other processors and/or components included in the system. Controller 814 may control the data paths in the ALU 804, FPLU 806 and/or DSPU 808. Controller 814 may be implemented as one or more state machines, data paths and/or dedicated control logic. The gates of controller 814 may be implemented as standalone gates, FPGA, ASIC or any other suitable technology.

The registers 812 and the cache 810 may communicate with controller 814 and core 802 via internal connections 820A, 820B, 820C and 820D. Internal connections may be implemented as a bus, multiplexer, crossbar switch, and/or any other suitable connection technology.

Inputs and outputs for the processor 800 may be provided via a bus 816, which may include one or more conductive lines. The bus 816 may be communicatively coupled to one or more components of processor 800, for example the controller 814, cache 810, and/or register 812. The bus 816 may be coupled to one or more components of the system.

The bus 816 may be coupled to one or more external memories. The external memories may include Read Only Memory (ROM) 832. ROM 832 may be a masked ROM, Electronically Programmable Read Only Memory (EPROM) or any other suitable technology. The external memory may include Random Access Memory (RAM) 833. RAM 833 may be a static RAM, battery backed up static RAM, Dynamic RAM (DRAM) or any other suitable technology. The external memory may include Electrically Erasable Programmable Read Only Memory (EEPROM) 835. The external memory may include Flash memory 834. The External memory may include a magnetic storage device such as disc 836. In some embodiments, the external memories may be included in a system.

The terms “in response to”, “based on”, “as a function of”, and “in dependence on” may be interchanged.

It will be appreciated that the above description for clarity has described embodiments of the invention with reference to different functional circuits, units and processors. However, it will be apparent that any suitable distribution of functionality between different functional circuits, units or processors may be used without detracting from the invention. For example, functionality illustrated to be performed by separate processors or controllers may be performed by the same processor or controllers. Hence, references to specific functional units or circuits are only to be seen as references to suitable means for providing the described functionality rather than indicative of a strict logical or physical structure or organization.

The invention can be implemented in any suitable form including hardware, software, firmware or any combination of these. The invention may optionally be implemented at least partly as computer software running on one or more data processors and/or digital signal processors. The elements and components of an embodiment of the invention may be physically, functionally and logically implemented in any suitable way. Indeed, the functionality may be implemented in a single unit, in a plurality of units or as part of other functional units. As such, the invention may be implemented in a single unit or may be physically and functionally distributed between different units, circuits and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

According to an aspect of the invention, the method of the claims and/or description is a method excluding a method for performing mental acts as such.

Furthermore, although individually listed, a plurality of means, elements, circuits or method steps may be implemented by, e.g., a single circuit, unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category but rather indicates that the feature is equally applicable to other claim categories as appropriate. Furthermore, the order of features in the claims do not imply any specific order in which the features must be worked and in particular the order of individual steps in a method claim does not imply that the steps must be performed in this order. Rather, the steps may be performed in any suitable order. In addition, singular references do not exclude a plurality. Thus, references to “a”, “an”, “first”, “second” etc. do not preclude a plurality. Reference signs in the claims are provided merely as a clarifying example shall not be construed as limiting the scope of the claims in any way.

Generally, examples of an audio apparatus, a method of generating a set of output audio signals, and a computer program which are indicated by below embodiments.

### EMBODIMENTS

1. An audio apparatus for generating a set of output audio signals, the audio apparatus comprising:
a receiver (101) arranged to receive a set of input audio signals;
a segmenter (103) arranged to segment the set of input audio signals into time segments;
an output signal generator (105) arranged to generate the set of output audio signals, each output audio signal of the set of output audio signals being linked with an input audio signal of the set of input audio signals, the output signal generator (105) being arranged to for each time segment perform the steps of:
   generating (201) a frequency bin representation of the set of input audio signals, each frequency bin of the frequency bin representation of the set of input audio signals comprising a frequency bin value for each of the input audio signals of the set of input audio signals;
   generating (203) a frequency bin representation of the set of output audio signals, each frequency bin of the frequency bin representation of a set of output audio signals comprising a frequency bin value for each of the set of output audio signals, the frequency bin value for a given output audio signal of the set of output audio signals for a given frequency bin being generated as a weighted combination of frequency bin values of the set of input audio signals for the given frequency bin;
   generating (205) a time domain representation for each output audio signal from the frequency bin representation of the set of output audio signals;
an adapter (107) arranged to update weights of the weighted combination;
wherein the adapter (107) is arranged to update a first weight for a contribution to a first frequency bin value of a first frequency bin for a first output audio signal linked with a first input audio signal from a second frequency bin value of the first frequency bin for a second input audio signal linked to a second output audio signal in response to a correlation measure between a first previous frequency bin value of the first output audio signal for the first frequency bin and a second previous frequency bin value of the second output audio signal for the first frequency bin.

2. The audio apparatus of 1 wherein the adapter (107) is arranged to update the first weight in response to a product of a first value and a second value, the first value being one of the first previous frequency bin value and the second previous frequency bin value and the second value being a complex conjugate of the other of the first previous frequency bin value and the second previous frequency bin value.

3. The apparatus of 1 or 2 wherein the adapter (107) is arranged to update a second weight being for a contribution to the first frequency bin value from a third frequency bin value being a frequency bin value of the first frequency bin for the first input audio signal in response to a magnitude of the first previous frequency bin value.

4. The apparatus of 1 or 2 wherein the adapter (107) is arranged to set a second weight being for a contribution to the first frequency bin value from a third frequency bin value being a frequency bin value of the first frequency bin for the first input audio signal to a predetermined value.

5. The apparatus of any of the above wherein the adapter (107) is arranged to constrain a weight for a contribution to the first frequency bin value from a third frequency bin value being a frequency bin value of the first frequency bin for the first input audio signal to be a real value.

6. The apparatus of any of the above wherein the adapter (107) is arranged to set a third weight being a weight for a contribution to a fourth frequency bin value of the first frequency bin for the second output audio signal from the first input audio signal to be a complex conjugate of the first weight.

7. The apparatus of any of the above wherein weights of the weighted combination for other input audio signals than the first input audio signal are complex valued weights.

8. The apparatus of any of the above wherein the adapter (107) is arranged to determine output bin values for the given frequency bin w from:

y(ω)=W(ω)x(ω)
where y(ω) is a vector comprising the frequency bin values for the output audio signals for the given frequency bin ω; x(ω) is a vector comprising the frequency bin values for the input audio signals for the given frequency bin ω; and W(ω) is a matrix having rows comprising weights of a weighted combination for the output audio signals.

9. The apparatus of any of the above wherein the adapter (107) is arranged to adapt weights wᵢⱼ of the matrix W(ω) according to:

$${w}_{ij} ( k + 1 , ω ) = {w}_{ij} ( k , ω ) - η ( k , ω ) [ {y}_{i} ( k , ω ) {y}_{j}^{*} ( k , ω ) ]$$

where i is a row index of the matrix W(ω), j is a column index of the matrix W(ω), k is a time segment index, ω represents the frequency bin, and η(k,ω) is a scaling parameter for adapting an adaptation speed.

10. The apparatus of any of the above wherein the adapter (107) is arranged to compensate the correlation value for a signal level of the first frequency bin.

11. The apparatus any of the above where the adapter (107) is arranged to initialize the weights for the weighted combination to comprise at least one zero value weight and one non-zero value weight.

12. The apparatus any of the above wherein the weighted combination comprises applying a time domain windowing to a frequency representation of weights formed by weights for the first input audio signal and the second input audio signal for different frequency bins.

13. A method of generating a set of output audio signals:
receiving a set of input audio signals;
segmenting the set of input audio signals into time segments;
generating the set of output audio signals, each output audio signal of the set of output audio signals being linked with one input audio signal of the set of input audio signals, wherein generating the set of output audio signals comprises for each time segment performing the steps of:
   generating (201) a frequency bin representation of the set of input audio signals, each frequency bin of the frequency bin representation of the set of input audio signals comprising a frequency bin value for each of the input audio signals of the set of input audio signals;
   generating (203) a frequency bin representation of the set of output audio signals, each frequency bin of the frequency bin representation of a set of output audio signals comprising a frequency bin value for each of the output audio signals, the frequency bin value for a given output audio signal of the set of output audio signals for a given frequency bin being generated as a weighted combination of frequency bin values of the set of input audio signals for the given frequency bin;
   generating (205) a time domain representation for each output audio signal from the frequency bin representation of the set of output audio signals;
and the method further comprises updating weights of the weighted combination including updating a first weight for a contribution to a first frequency bin value of a first frequency bin for a first output audio signal linked with a first input audio signal from a second frequency bin value of the first frequency bin for a second input audio signal linked to a second output audio signal in response to a correlation measure between a first previous frequency bin value of the first output audio signal for the first frequency bin and a second previous frequency bin value of the second output audio signal for the first frequency bin.

14. A computer program product comprising computer program code means adapted to perform all the steps of the above method(s) when said program is run on a computer.

More specifically, the invention is defined by the appended CLAIMS.

1. An audio decorrelation apparatus for generating a set of output audio signals being decorrelated signals of a set of input audio signals, the audio apparatus comprising:
a receiver arranged to receive the set of input audio signals;
a segmenter arranged to segment the set of input audio signals into time segments;
an output signal generator arranged to generate the set of output audio signals, each output audio signal of the set of output audio signals being linked with an input audio signal of the set of input audio signals, the output signal generator being arranged to for each time segment perform the steps of:
generating a frequency bin representation of the set of input audio signals, each frequency bin of the frequency bin representation of the set of input audio signals comprising a frequency bin value for each of the input audio signals of the set of input audio signals;
generating a frequency bin representation of the set of output audio signals, each frequency bin of the frequency bin representation of a set of output audio signals comprising a frequency bin value for each of the set of output audio signals, the frequency bin value for a given output audio signal of the set of output audio signals for a given frequency bin being generated as a weighted combination of frequency bin values of the set of input audio signals for the given frequency bin;
generating a time domain representation for each output audio signal from the frequency bin representation of the set of output audio signals;
an adapter arranged to update weights of the weighted combination;
wherein the adapter is arranged to update a first weight for a contribution to a first frequency bin value of a first frequency bin for a first output audio signal linked with a first input audio signal from a second frequency bin value of the first frequency bin for a second input audio signal linked to a second output audio signal dependent on a correlation measure between a first previous frequency bin value of the first output audio signal for the first frequency bin and a second previous frequency bin value of the second output audio signal for the first frequency bin; and wherein
the adapter is further arranged to update a second weight being for a contribution to the first frequency bin value from a third frequency bin value being a frequency bin value of the first frequency bin for the first input audio signal dependent on a magnitude of the first previous frequency bin value.

2. The audio decorrelation apparatus of claim 1 wherein the adapter is arranged to update the first weight in response to a product of a first value and a second value, the first value being one of the first previous frequency bin value and the second previous frequency bin value and the second value being a complex conjugate of the other of the first previous frequency bin value and the second previous frequency bin value.

3. The audio decorrelation apparatus of claim 1 wherein the adapter is arranged to constrain a weight for a contribution to the first frequency bin value from a third frequency bin value being a frequency bin value of the first frequency bin for the first input audio signal to be a real value.

4. The audio decorrelation apparatus of claim 1 wherein the adapter is arranged to set a third weight being a weight for a contribution to a fourth frequency bin value of the first frequency bin for the second output audio signal from the first input audio signal to be a complex conjugate of the first weight.

5. The audio decorrelation apparatus of claim 1 wherein weights of the weighted combination for other input audio signals than the first input audio signal are complex valued weights.

6. The audio decorrelation apparatus of claim 1 wherein the adapter is arranged to determine output bin values for the given frequency bin ω from:
y(ω)=W(ω)×(ω)
where y(ω) is a vector comprising the frequency bin values for the output audio signals for the given frequency bin ω; x(ω) is a vector comprising the frequency bin values for the input audio signals for the given frequency bin ω; and W(ω) is a matrix having rows comprising weights of a weighted combination for the output audio signals.

7. The audio decorrelation apparatus of claim 6 wherein the adapter is arranged to adapt weights wᵢⱼ of the matrix W(ω) according to:
$${w}_{ij} ( k + 1 , ω ) = {w}_{ij} ( k , ω ) - η ( k , ω ) [ {y}_{i} ( k , ω ) {y}_{j}^{*} ( k , ω ) ]$$
where i is a row index of the matrix W(ω), j is a column index of the matrix W(ω), k is a time segment index, ω represents the frequency bin, and η(k, ω) is a scaling parameter for adapting an adaptation speed.

8. The audio decorrelation apparatus of claim 1 wherein the adapter is arranged to compensate the correlation value for a signal level of the first frequency bin.

9. The audio decorrelation apparatus of claim 1 where the adapter is arranged to initialize the weights for the weighted combination to comprise at least one zero value weight and one non-zero value weight.

10. The audio decorrelation apparatus of claim 1 wherein the weighted combination comprises applying a time domain windowing to a frequency representation of weights formed by weights for the first input audio signal and the second input audio signal for different frequency bins.

11. An audio apparatus comprising the audio decorrelation apparatus of claim 1 and further comprising:
an audio beamformer arranged to receive the set of output audio signals and to perform an audio beamforming to generate a beamformed audio output signal.

12. The audio apparatus of claim 11 wherein the audio beamforming is an adaptive audio beamforming.

13. A method of generating a set of output audio signals being decorrelated signals of a set of input audio signals:
receiving the set of input audio signals;
segmenting the set of input audio signals into time segments;
generating the set of output audio signals, each output audio signal of the set of output audio signals being linked with one input audio signal of the set of input audio signals, wherein generating the set of output audio signals comprises for each time segment performing the steps of:
generating a frequency bin representation of the set of input audio signals, each frequency bin of the frequency bin representation of the set of input audio signals comprising a frequency bin value for each of the input audio signals of the set of input audio signals;
generating a frequency bin representation of the set of output audio signals, each frequency bin of the frequency bin representation of a set of output audio signals comprising a frequency bin value for each of the output audio signals, the frequency bin value for a given output audio signal of the set of output audio signals for a given frequency bin being generated as a weighted combination of frequency bin values of the set of input audio signals for the given frequency bin;
generating a time domain representation for each output audio signal from the frequency bin representation of the set of output audio signals;
and the method further comprises updating weights of the weighted combination including updating a first weight for a contribution to a first frequency bin value of a first frequency bin for a first output audio signal linked with a first input audio signal from a second frequency bin value of the first frequency bin for a second input audio signal linked to a second output audio signal in response to a correlation measure between a first previous frequency bin value of the first output audio signal for the first frequency bin and a second previous frequency bin value of the second output audio signal for the first frequency bin;
and wherein updating weights of the weighted combination comprises updating a second weight being for a contribution to the first frequency bin value from a third frequency bin value being a frequency bin value of the first frequency bin for the first input audio signal in response to a magnitude of the first previous frequency bin value.

14. A computer program product comprising computer program code means adapted to perform all the steps of claim 13 when said program is run on a computer.
